(19) United States
(12) Patent Application Publication
(10) Pub. No.: US 2020/0125009 A1
(43) Pub. Date: Apr. 23, 2020

(54) INTERMEDIATE TRANSFER MEMBER AND METHOD OF PRODUCTION THEREOF

(71) Applicant: Hewlett-Packard Development Company, L.P., Spring, TX (US)

(72) Inventors: Tony Azzam, Nes Ziona (IL); Ira YUDOViN-FARBER, Nes Ziona (IL); Dina VOLOSHIN FIROUZ, Nes Ziona (IL); Sergey INOTAEV, Nes Ziona (IL)

(73) Assignee: Hewlett-Packard Development Company, L.P., Spring, TX (US)

(21) Appl. No.: 16/619,537

(22) PCT Filed: Apr. 5, 2018
(86) PCT No.: PCT/US2018/026196

§ 371 Date: Dec. 5, 2019

(30) Foreign Application Priority Data
Oct. 13, 2017 (EP) PCT/EP2017/076186

(51) Int. Cl. G03G 15/16; C08G 77/20; C08K 3/04

(52) U.S. Cl. CPC G03G 15/162; C08K 2201/001; C08K 3/04; C08G 77/20

(57) ABSTRACT

An intermediate transfer member for digital offset printing is described, comprising a UV-A cured silicone release formulation. There is also described a method of producing an intermediate transfer member, and a UV-A curable silicone release formulation for an intermediate transfer member.

Digital offset printing apparatus typically include an intermediate transfer member (ITM) onto which an image is applied prior to transferring the image to a substrate. Current intermediate transfer members comprise a silicone release layer as the surface layer onto which the ink image is applied. Conventionally, silicone release layers are formed either by condensation curing or thermally assisted addition curing reactions.

### BRIEF DESCRIPTION OF THE FIGURES

FIG. 1 is a schematic illustration of an example of a digital offset printing apparatus, in this case, a liquid electrostatic printing apparatus.

FIG. 2 is a cross-sectional diagram of an example of an intermediate transfer member (ITM).

FIG. 3 is a schematic cross-sectional diagram of an example of an ITM structure.

FIG. 4 is a schematic cross-sectional diagram of another example of an ITM structure.

FIG. 5 is a graph showing the viscosity at room temperature of samples of UV-A curable silicone release formulations kept in the dark over a period of two weeks.

FIG. 6 shows an ATR-FTIR (Attenuated total reflection Fourier-transform infrared spectroscopy) spectrum of a UV-A curable silicone release formulation as the curing reaction progresses.

FIG. 7 is a graph showing the % conversion of the curing reaction of a UV-A curable silicone release formulation as a function of UV-A exposure cycles.

FIG. 8 is a graph showing the % conversion of the curing reaction of a UV-A curable silicone release formulation vs the total accumulated energy.

### DETAILED DESCRIPTION

Before the intermediate transfer member and related aspects are disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a”, “an”, and “the” include plural referents unless the context clearly dictates otherwise.

As used herein, “UV-A light” or “UV-A radiation” refers to electromagnetic radiation having a wavelength in the range of about 315 nm to about 410 nm, for example about 320 nm to about 410 nm, about 340 nm to about 410 nm, about 340 nm to about 400 nm, about 360 nm to about 410 nm, about 365 nm to about 405 nm, about 365 to about 400 nm, or about 395 nm. The term “UV-A source” refers to is a source of UV-A radiation, for example UV-LED.

As used herein, “UV-A photoinitiator” refers to a photoinitiator or photo-catalyst that is activatable on exposure to “UV-A radiation”. Such UV-A photoinitiators are available commercially, an example is QPI-3100™ (available from Polymer-G, Israel) which is designed for curing under UV-A with a wavelength of 395 nm (UV-LED at 395 nm).

As used herein, “electrophotographic ink composition” generally refers to an ink composition that is typically suitable for use in an electrophotographic printing process, sometimes termed an electrostatic printing process. The electrophotographic ink composition may include chargeable particles of the resin and the pigment dispersed in a liquid carrier, which may be as described herein.

The LEP inks referred to herein may comprise a colourant and a thermoplastic resin dispersed in a carrier liquid. In some examples, the thermoplastic resin may comprise an ethylene acrylic acid resin, an ethylene methacrylic acid resin or combinations thereof. In some examples, the electrostatic ink also comprises a charge director and/or a charge adjuvant. In some examples, the liquid electrostatic inks described herein may be Electrolnk® and any other Liquid Electro Photographic (LEP) inks developed by Hewlett-Packard Company.

As used herein, “liquid carrier”, “carrier liquid”, “carrier,” or “carrier vehicle” refers to the fluid in which resin, pigment, charge directors and/or other additives can be dispersed to form a liquid electrostatic ink or electrophotographic ink. The carrier liquid may include a mixture of a variety of different agents, such as surfactants, co-solvents, viscosity modifiers, and/or other possible ingredients. The carrier liquid can include or be a hydrocarbon, silicone oil, vegetable oil, etc. The carrier liquid can include, for example, an insulating, non-polar, non-aqueous liquid that can be used as a medium for the first and second resin components. The carrier liquid can include compounds that have a resistivity in excess of about 10⁹ ohm·cm. The carrier liquid may have a dielectric constant below about 5, in some examples below about 3. The carrier liquid may include hydrocarbons. In some examples, the carrier liquid comprises or consists of, for example, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION).

As used herein, “copolymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

Unless otherwise stated, viscosity was measured using an AR-2000 model Rheometer from TAI (Thermal Analysis Instruments)). The rheometer is used as a viscometer, by applying shear forces on the testing sample between two parallel plates. The sample is loaded between parallel plates at a known gap with an oscillatory (sinusoidal) shear profile of from 0.01 to 1,000 s⁻¹ at a temperature of 25° C. applied.

As used herein, “electrophotographic printing” or “electrostatic printing” generally refers to the process that provides an image that is transferred from a photoimaging plate either directly, or indirectly via an intermediate transfer member, to a print substrate. As such, the image is not substantially absorbed into the photoimaging plate on which it is applied. Additionally, “electrophotographic printers”, “electrophotographic printing apparatus”, “electrostatic printing apparatus” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field gradient of 1000 V/cm or more, or in some examples 1500 V/cm or more.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

Unless otherwise stated, any feature described herein can be combined with any aspect or any other feature described herein.

In an aspect, there is provided a method of producing an intermediate transfer member for digital offset printing. In some examples, the method comprises:
applying onto an intermediate transfer member body a UV-A curable silicone release formulation;
curing the UV-A curable silicone release formulation to form a cured silicone release layer,
   wherein the UV-A curable silicone release formulation comprises:
a polyalkylsiloxane containing at least two vinyl groups;
a polyalkylsiloxane cross-linker containing at least two Si—H bonds; and
a UV-A photoinitiator,
   and curing the UV-A curable silicone release formulation comprises irradiating the UV-A curable silicone release layer with UV-A light.

In another aspect, there is provided an intermediate transfer member for digital offset printing. In some examples, the intermediate transfer member comprises a UV-A cured silicone release layer comprising a cured UV-A curable silicone release formulation, the UV-A curable silicone release formulation comprising:
a polyalkylsiloxane containing at least two vinyl groups;
a polyalkylsiloxane cross-linker containing at least two Si—H bonds; and
a UV-A photoinitiator.

In a further aspect, there is provided a UV-A curable silicone release formulation for an intermediate transfer member of a digital offset printing apparatus. In some examples the UV-A curable silicone release formulation comprises:
a vinyl-terminated polyalkylsiloxane having the following formula:

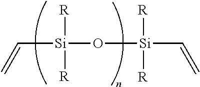

wherein
each R is independently selected from C1 to C6 alkyl; and
n is 1 or more;
   a pendent vinyl polyalkylsiloxane having the following formula:

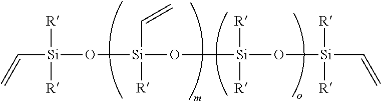

wherein
each R′ is independently selected from C1 to C6 alkyl;
m is 1 or more; and
o is 0 or more;
   a polyalkylsiloxane cross-linker having the following formula,

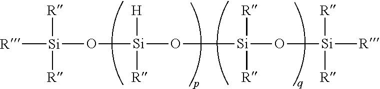

wherein
each R″ is independently selected from C1 to C6 alkyl;
each R′″ is independently selected from H and C1 to C6 alkyl;
p is 2 or more; and
q is 0 or more; and
a UV-A photoinitiator.

Some methods of producing silicone release layers involve either condensation curing or thermally assisted addition curing reactions. Condensation curing reactions of polydimethylsiloxanes with hydroxyl or ethoxy moieties in the presence of tin-based catalysts form highly cross-linked silicone layers. However, condensation cured silicone layers are highly moisture sensitive and often require special handling and rigorous conditions. Thermally assisted addition curing reactions of polydimethylsiloxanes with vinyl or hydride moieties in the presence of platinum catalysts form cross-linked silicone layers that are not sensitive to moisture but are highly sensitive to heat and generally require the use of inhibitors, often in large volumes, to provide the formulations with reasonable shelf-lives under ambient conditions. The inhibitors used gradually evaporate under ambient conditions, significantly increasing the viscosity of the formulation in an uncontrollable manner, resulting in variation in the properties and thickness of the silicone release layer. Despite utilising freshly prepared silicone release formulations, the thermal curing is uncontrollable, potentially necessitating the rejection of entire production batches of intermediate transfer members.

The present inventors have found that the UV-A cured silicone release layers of the present invention, triggered by a UV-A photoinitiator, result in controllable and swift curing of the silicone release formulation which also has improved stability.

### Digital Offset Printing Apparatus

In some examples, the digital offset printing apparatus may be any digital offset printing apparatus comprising an intermediate transfer member. In some examples, the digital offset printing apparatus may be a transfer inkjet printing apparatus or an electrostatic printing apparatus, for example, a dry toner electrostatic printing apparatus or a liquid electrostatic printing apparatus. In some examples, a transfer inkjet printing apparatus is an inkjet printing apparatus in which the ink is jetted onto an intermediate transfer member to form an image on the intermediate transfer member before the image is transferred from the intermediate transfer member to a substrate. In some examples, the digital offset printing apparatus is a liquid electrostatic (LEP) printing apparatus.

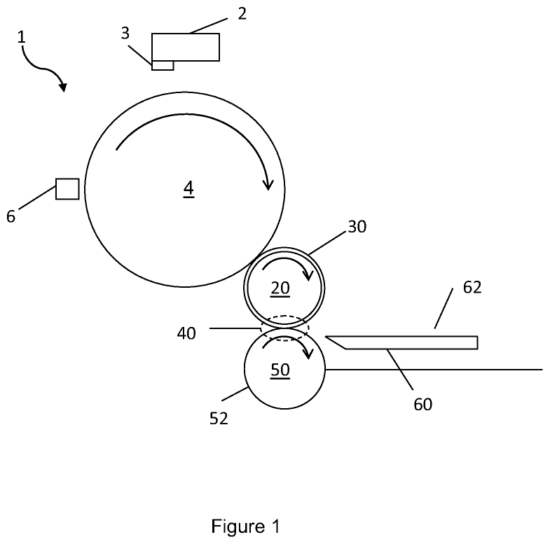

FIG. 1 shows a schematic illustration of an example of an LEP printing apparatus 1 and the use of an intermediate transfer member therein. An image, including any combination of graphics, text and images, is communicated to the LEP printing apparatus 1. The LEP printing apparatus includes a photo charging unit 2 and a photo-imaging cylinder 4. The image is initially formed on a photoimaging plate (also known as a photoconductive member), in this case in the form of photo-imaging cylinder 4, before being transferred to a silicone release layer 30 of the intermediate transfer member (ITM) 20 which is in the form of a roller (first transfer), and then from the UV-A cured silicone release layer 30 of the ITM 20 to a print substrate 62 (second transfer).

According to an illustrative example, the initial image is formed on rotating a photo-imaging cylinder 4 by a photo charging unit 2. Firstly, the photo charging unit 2 deposits a uniform static charge on the photo-imaging cylinder 4 and then a laser imaging portion 3 of the photo charging unit 2 dissipates the static charges in selected portions of the image area on the photo-imaging cylinder 4 to leave a latent electrostatic image. The latent electrostatic image is an electrostatic charge pattern representing the image to be printed. Liquid electrophotographic ink is then transferred to the photo-imaging cylinder 4 by a binary ink developer (BID) unit 6. The BID unit 6 presents a uniform film of liquid electrophotographic ink to the photo-imaging cylinder 4. The liquid electrophotographic ink contains electrically charged pigment particles which, by virtue of an appropriate potential on the electrostatic image areas, are attracted to the latent electrostatic image on the photo-imaging cylinder 4. The liquid electrophotographic ink does not adhere to the uncharged, non-image areas and forms a developed toner image on the surface of the latent electrostatic image. The photo-imaging cylinder 4 then has a single colour ink image on its surface.

The developed toner image is then transferred from the photo-imaging cylinder 4 to a silicone release layer 30 of an ITM 20 by electrical forces. The image is then dried and fused on the silicone release layer 30 of the ITM 20 before being transferred from the release layer 30 of the ITM 20 to a print substrate disposed on an impression cylinder 50. The process may then be repeated for each of the coloured ink layers to be included in the final image.

The image is transferred from a photo-imaging cylinder 4 to an ITM 20 by virtue of an appropriate potential applied between the photo-imaging cylinder 4 and the ITM 20, such that the charged ink is attracted to the ITM 20.

Between the first and second transfers, the solid content of the developed toner image is increased and the ink is fused on to the ITM 20. For example, the solid content of the developed toner image deposited on the silicone release layer 30 after the first transfer is typically around 20%, by the second transfer the solid content of the developed toner image is typically around 80-90%. This drying and fusing is typically achieved by using elevated temperatures and airflow-assisted drying. In some examples, the ITM 20 is heatable.

The print substrate 62 is fed into the printing apparatus by a print substrate feed tray 60 and is disposed on an impression cylinder 50. As the print substrate 62 contacts the ITM 20, the single colour image is transferred to the print substrate 62.

To form a single colour image (such as a black and white image), one pass of the print substrate 62 through the impression cylinder 50 and the ITM 20 completes the image. For a multiple colour image, the print substrate 62 may be retained on the impression cylinder 50 and make multiple contacts with the ITM 20 as it passes through the nip 40. At each contact an additional colour plane may be placed on the print substrate 62.

### Intermediate Transfer Member

The intermediate transfer member may be termed an ITM herein for brevity.

The intermediate transfer member for digital offset printing, may comprise a UV-A cured silicone release layer formed by UV-A curing a UV-A curable silicone release formulation comprising a polyalkylsiloxane containing at least two vinyl groups; a polyalkylsiloxane cross-linker containing at least two Si—H bonds; and a UV-A photoinitiator.

The ITM may comprise a supportive portion on which the UV-A cured silicone release layer is disposed. The supportive portion may be termed an intermediate transfer member body herein.

The ITM may have a base, for example, a metal base. The base may have a cylindrical shape. The base may form part of the supportive portion of the ITM.

The ITM may have a cylindrical shape; as such, the ITM may be suitable for use as a roller, for example, a roller in a digital offset printing apparatus.

The supportive portion of the ITM may comprise a layered structure disposed on the base of the ITM. The supportive portion may comprise a layer comprising a thermoplastic polyurethane.

The layered structure may comprise a compliant substrate layer, for example, a rubber layer or a layer comprising a thermoplastic polyurethane, on which the UV-A cured silicone release layer may be disposed. The compliant substrate layer may comprise a thermoplastic polyurethane layer or a rubber layer. The rubber layer may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM).

The ITM may comprise a primer layer to facilitate bonding or joining of the UV-A curable silicone release layer to the compliant layer. The primer layer may form part of the supportive portion of the ITM, in some examples, the primer layer is disposed on the compliant substrate layer.

In some examples, the primer layer may comprise an organosilane, for example, an organosilane derived from an epoxysilane such as 3-glycidoxypropyltrimethoxysilane, a vinyl silane such as vinyltriethoxysilane or vinyltrimethoxysilane, an allyl silane, an acryloxysilane such as 3-methacryloxypropyltrimethoxysilane, or an unsaturated silane, and a catalyst such as a catalyst comprising titanium or platinum.

The primer layer may be formed from a curable primer layer. The curable primer layer may be applied to the compliant substrate layer of the supportive portion of the ITM before a UV-A curable silicone release formulation is applied to the supportive portion. The curable primer layer may comprise an organosilane and a catalyst, for example, a catalyst comprising titanium and/or a catalyst comprising platinum.

In some examples, the organosilane contained in the curable primer layer is selected from an epoxysilane, a vinyl silane, an allyl silane and an unsaturated silane.

The curable primer layer may comprise a first primer and a first catalyst, and a second primer and, in some examples, a second catalyst. The first primer and/or the second primer may comprise an organosilane. The organosilane may be selected from an epoxysilane, a vinyl silane, an allyl silane and an unsaturated silane.

In some examples, the first catalyst is a catalyst for catalysing a condensation cure reaction, for example, a catalyst comprising titanium. The first primer may be cured by a condensation reaction by the first catalyst. The second primer may be cured by a condensation reaction by the first catalyst.

In some examples, the second catalyst is a catalyst for catalysing an addition cure reaction.

The curable primer layer may be applied to the compliant layer as a composition containing the first and second primer and first and second catalyst.

In some examples the curable primer layer may be applied to the compliant layer as two separate compositions, one containing the first primer and first catalyst, the other containing the second primer and second catalyst. In some examples, the curable primer layer may be applied as two separate compositions, one containing the first primer (e.g., (3-glycidoxypropyl)trimethoxysilane and/or 3-methacryloxypropyltrimethoxysilane) and a photoinitiator (e.g., 2-hydroxy-2-methylpropiophenone), the other containing the second primer (e.g., (3-glycidoxypropyl)trimethoxysilane and/or vinyltrimethoxysilane) and a catalyst (e.g., titanium diisopropoxide bis(acetylacetonate) and/or platinum divinyltetramethyldisiloxane).

In some examples, the ITM may comprise an adhesive layer for joining the compliant substrate layer to the base. The adhesive layer may be a fabric layer, for example, a woven or non-woven cotton, synthetic, combined natural and synthetic, or treated, for example, treated to have improved heat resistance, material.

The compliant substrate layer may be formed of a plurality of compliant layers. For example, the compliant substrate layer may comprise a compressible layer, a compliance layer and/or a conductive layer. A “conductive layer” may be a layer comprising electrically conductive particles. In some examples, any one or more of the plurality of compliant layers may comprise a thermoplastic polyurethane.

In some examples, the compressible layer is disposed on the base of the ITM. The compressible layer may be joined to the base of the ITM by the adhesive layer. A conductive layer may be disposed on the compressible layer. The compliance layer may then be disposed on the conductive layer, if present, or disposed on the compressible layer if no conductive layer is present. If the compressible layer and/or the compliance layer are partially conducting there may be no requirement for an additional conductive layer.

The compressible layer may have a large degree of compressibility. In some examples, the compressible layer may be 600 μm thick.

The compressible layer may comprise a thermoplastic polyurethane layer, a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). In some examples, the compressible layer may comprise carbon black to increase its thermal conductivity.

In some examples, the compressible layer includes small voids, which may be as a result of microspheres or blowing agents used in the formation of the compressible layer. In some examples, the small voids comprise about 40% to about 60% by volume of the compressible layer.

The compliance layer may comprise a thermoplastic polyurethane, a soft elastomeric material having a Shore A hardness value of less than about 65, or a Shore A hardness value of less than about 55 and greater than about 35, or a Shore A hardness value of between about 42 and about 45. In some examples, the compliance layer comprises a polyurethane, a thermoplastic polyurethane or an acrylic. Shore A hardness is determined by ASTM standard D2240.

In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM). In some examples, the compliance layer comprises a thermoplastic polyurethane.

In an example the compressible layer and the compliance layer are formed from the same material.

The conductive layer may comprise a rubber, for example, an acrylic rubber (ACM), a nitrile rubber (NBR), a hydrogenated nitrile rubber (HNBR), or an EPDM rubber (an ethylene propylene diene terpolymer), and one or more conductive materials, including but not limited to carbon black or metallic particles. In some examples, the conductive layer may comprise a thermoplastic polyurethane and one or more conductive materials, including but not limited to carbon black or metallic particles.

In some examples, the compressible layer and/or the compliance layer may be made to be partially conducting with the addition of conducting particles, for example, conductive carbon black, metal particles or metal fibres. In some examples, where the compressible layer and/or the compliance layer are partially conducting there may be no requirement for an additional conductive layer.

In some examples, the intermediate transfer member comprises, in the following order:
a. a fabric layer;
b. a compressible layer, which may have voids therein;
c. a layer comprising electrically conductive particles;
d. a compliant layer;
e. a primer layer; and
f. a UV-A cured silicone release layer.

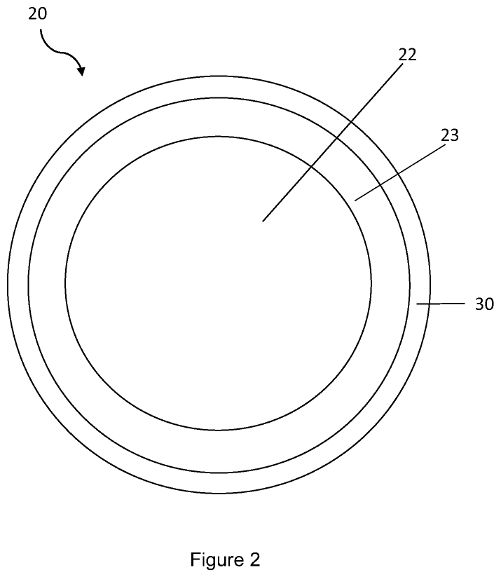

FIG. 2 is a cross-sectional diagram of an example of an ITM. The ITM includes a supportive portion comprising a base 22 and a substrate layer 23 disposed on the base 22. The base 22 may be a metal cylinder. The substrate layer 23 may comprise or be a thermoplastic polyurethane layer. The ITM 20 also comprises a UV-A cured silicone release layer 30 disposed on the substrate layer 23.

The substrate layer 23 may comprise or further comprise (if it also comprises a thermoplastic polyurethane layer) a rubber layer which may comprise an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ or FLS), a fluorocarbon rubber (FKM or FPM) or a perfluorocarbon rubber (FFKM). For example, the rubber layer may comprise an at least partly cured acrylic rubber, for example an acrylic rubber comprising a blend of acrylic resin Hi-Temp 4051 EP (Zeon Europe GmbH, Niederkasseler Lohweg 177, 40547 Disseldorf, Germany) filled with carbon black pearls 130 (Cabot, Two Seaport Lane, Suite 1300, Boston, Mass. 02210, USA) and a curing system which may comprise, for example, NPC-50 accelerator (ammonium derivative from Zeon).

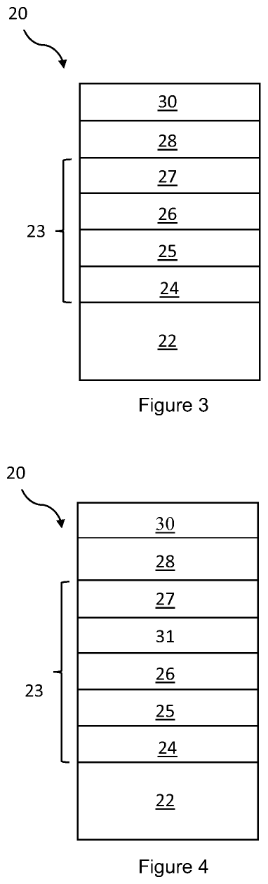

FIG. 3 shows a cross-sectional view of an example of an ITM having a substrate layer 23 comprising an adhesive layer 24 disposed between the base 22 and a compressible layer 25 for joining the compressible layer 25 of the substrate layer 23 to the base 22, a conductive layer 26 may be disposed on the compressible layer 25, and a compliance layer 27 (also called a soft compliant layer) may be disposed on the conductive layer 26. A primer layer 28 is disposed between the substrate layer 23 and the UV-A cured silicone release layer 30. At least one of the layers 24 to 27 may comprise a thermoplastic polyurethane.

FIG. 4 shows a cross-sectional view of an ITM having a substrate layer 23 comprising an adhesive layer 24 disposed between the base 22 and a compressible layer 25 for joining the compressible layer 25 of the substrate layer 23 to the base 22, a conductive layer 26 is disposed on the compressible layer 25, a layer comprising a thermoplastic polyurethane 31 is disposed on the conductive layer 26, and a compliance layer 27 (also called a soft compliant layer) is disposed on the conductive layer 26. The UV-A cured silicone release layer 30 is disposed on a primer layer 28, which is disposed on the compliance layer 27.

The adhesive layer may be a fabric layer, for example a woven or non-woven cotton, synthetic, combined natural and synthetic, or treated, for example, treated to have improved heat resistance, material. In an example the adhesive layer 23 is a fabric layer formed of NOMEX material having a thickness, for example, of about 200 μm.

The compressible layer 25 may be a rubber layer which, for example, may comprise an acrylic rubber (ACM), a nitrile rubber (NBR), a hydrogenated nitrile rubber (HNBR), a polyurethane elastomer (PU), an EPDM rubber (an ethylene propylene diene terpolymer), or a fluorosilicone rubber (FLS). The compressible layer may comprise a thermoplastic polyurethane.

The compliance layer 27 may comprise a soft elastomeric material having a Shore A hardness value of less than about 65, or a Shore A hardness value of less than about 55 and greater than about 35, or a Shore A hardness value of between about 42 and about 45. In some examples, the compliance layer 27 comprises a polyurethane or acrylic. In some examples, the compliance layer 27 comprises a thermoplastic polyurethane. Shore A hardness is determined by ASTM standard D2240. In some examples, the compliance layer comprises an acrylic rubber (ACM), a nitrile rubber (NBR), a hydrogenated nitrile rubber (HNBR), a polyurethane elastomer (PU), an EPDM rubber (an ethylene propylene diene terpolymer), a fluorosilicone rubber (FMQ), a fluorocarbon rubber (FKM or FPM) or a perfluorocarbon rubber (FFKM)

In an example, the compressible layer 25 and the compliance layer 27 are formed from the same material.

In some examples, the conductive layer 26 comprises a rubber, for example, an acrylic rubber (ACM), a nitrile rubber (NBR), a hydrogenated nitrile rubber (HNBR), or an EPDM rubber (an ethylene propylene diene terpolymer), and one or more conductive materials. In some examples, the conductive layer 26 comprises a thermoplastic polyurethane and one or more conductive materials. In some examples, the conductive layer 26 may be omitted, such as in some examples in which the compressible layer 25, the compliance layer 27, or the UV-A cured silicone release layer 30 are partially conducting. For example, the compressible layer 25 and/or the compliance layer 27 may be made to be partially conducting with the addition of conductive carbon black or metal fibres.

The primer layer 28 may be provided to facilitate bonding or joining of the release layer 30 to the substrate layer 23. The primer layer 28 may comprise an organosilane, for example, an organosilane derived from an epoxysilane such as 3-glycidylpropyl trimethoxysilane, a vinyl silane such as vinyltriethoxysilane or vinyltrimethoxysilane, an allyl silane, an unsaturated silane or a (meth)acrylic silane, for example, 3-methacryloxypropyltrimethoxysilane, and a catalyst such as a catalyst comprising titanium or platinum.

In an example, a curable primer layer 28 is applied to a compliance layer 27 of a substrate layer 23, for example, to the outer surface of a compliance layer 27 made from an acrylic rubber. The curable primer may be applied using a rod coating process. The curable primer may comprise a first primer comprising an organosilane and a first catalyst comprising titanium, for example an organic titanate or a titanium chelate. In an example, the organosilane is an epoxysilane, for example, 3-glycidoxypropyl trimethoxysilane (available from ABCR GmbH & Co. KG, Im Schlehert 10 D-76187, Karlsruhe, Germany, product code SIG5840) and vinyltriethoxysilane (VTEO, available from Evonik, Kirschenallee, Darmstadt, 64293, Germany), vinyltrimethoxysilane, an allyl silane, an unsaturated silane or a (meth)acrylic silane, for example, 3-methacryloxypropyltrimethoxysilane. The first primer is curable by, for example, a condensation reaction. For example, the first catalyst for a silane condensation reaction may be an organic titanate such as Tyzor® AA75 (available from Dorf-Ketal Chemicals India Private Limited Dorf Ketal Tower, D'Monte Street, Orlem, Malad (W), Mumbai-400064, Maharashtra, INDIA.). The primer may also comprise a second primer comprising an organosilane, e.g., a vinyl siloxane, such as a vinyl silane, for example, vinyl triethoxy silane, vinyltrimethoxysilane, an allyl silane, an unsaturated silane or a (meth)acrylic silane, for example, 3-methacryloxypropyltrimethoxysilane, and, in some examples, a second catalyst. The second primer may also be curable by a condensation reaction. The second catalyst, if present, may be different from the first catalyst and in some examples comprises platinum or rhodium. For example, the second catalyst may be a Karstedt catalyst with, for example, 9% platinum in solution (available from Johnson Matthey, 5th Floor, 25 Farringdon Street, London EC4A 4AB, United Kingdom) or a SIP6831.2 catalyst (available from Gelest, 11 East Steel Road, Morrisville, Pa. 19067, USA). This second primer may be cured by an addition reaction. The second catalyst in the second primer may be in contact with a pre-cure UV-A curable silicone release formulation applied onto the primer layer 28.

The curable primer layer applied to the substrate layer 23 may comprise a first primer and/or a second primer as described herein. The curable primer layer may be applied to the substrate layer 23 as two separate layers, one layer containing the first primer and the other layer containing the second primer.

The rubbers of the compressible layer 25, the conductive layer 26 and/or the compliance layer 27 of the substrate layer 23 may be uncured when the curable primer layer is applied thereon.

The silicone release layer 30 of the ITM 20 may be a UV-A cured silicone release layer that is formed by UV-A curing a UV-A curable silicone release formulation as described herein.

The silicone release layer 30 may be formed on the ITM by applying a layer of the UV-A curable silicone release formulation to a supportive portion of the ITM. For example, the silicone release layer may be applied to the substrate layer 23 or on top of a curable primer layer which has already been applied to the substrate layer 23. The curable primer layer and the silicone release layer may have been cured at the same time.

In some examples, once cured, the ITM comprises an UV-A cured silicone release layer 30 disposed on a substrate layer 23, or, if present, disposed on a primer layer 28.

In some examples, the UV-A curable silicone release formulation forms a silicone polymer matrix on UV-A curing, thus forming the UV-A cured silicone release layer.

### UV-A Curable Silicone Release Formulation

The UV-A curable silicone release formulation comprises a polyalkylsiloxane containing at least two vinyl groups; a polyalkylsiloxane cross-linker containing at least two Si—H bonds; and a UV-A photoinitiator.

In some examples, the UV-A curable silicone release formulation may comprise a polyalkylsiloxane containing at least two vinyl groups; a polyalkylsiloxane cross-linker containing at least two Si—H bonds; a UV-A photoinitiator; and conductive particles.

In some examples, the UV-A curable silicone release formulation may comprise a polyalkylsiloxane containing at least two vinyl groups; a polyalkylsiloxane cross-linker containing at least two Si—H bonds; a UV-A photoinitiator; and a thermal inhibitor. In some examples, the UV-A curable silicone release formulation may comprise a polyalkylsiloxane containing at least two vinyl groups; a polyalkylsiloxane cross-linker containing at least two Si—H bonds; a UV-A photoinitiator; conductive particles and a thermal inhibitor.

### Polyalkylsiloxane Containing at Least Two Vinyl Groups

In some examples, the UV-A curable silicone release formulation comprises a polyalkylsiloxane containing at least two vinyl groups. In some examples, the polyalkylsiloxane containing at least two vinyl groups is selected from a linear polyalkylsiloxane containing at least two vinyl groups, a branched polyalkylsiloxane containing at least two vinyl groups, a cyclic polyalkylsiloxane containing at least two vinyl groups and mixtures thereof. In some examples, the polyalkylsiloxane containing at least two vinyl groups is a linear polyalkylsiloxane containing at least two vinyl groups.

In some examples, the polyalkylsiloxane containing at least two vinyl groups comprises a vinyl-terminated polyalkylsiloxane having the following formula:

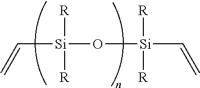

wherein each R is independently selected from C1 to C6 alkyl; and n is 1 or more.

In some examples, each R is independently selected from C1, C2, C3, C4, C5 and C6 alkyl. In some examples, each R is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R is independently selected from methyl, ethyl, n-propyl, isopropyl, n-butyl, sec-butyl, isobutyl, and tert-butyl. In some examples, each R is independently selected from methyl, ethyl, n-propyl, and isopropyl. In some examples, each R is the same. In some examples, each R is methyl.

In some examples, n is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, n is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less, in some examples, 2 or less. In some examples, n is 1 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, the vinyl-terminated polyalkylsiloxane has a viscosity at 25° C. of 250 mPa·s or more, in some examples, 300 mPa·s or more, in some examples, 350 mPa·s or more, in some examples, 400 mPa·s or more, in some examples, 450 mPa·s or more, in some examples, 500 mPa·s or more, in some examples, 550 mPa·s or more, in some examples 600 mPa·s or more, in some examples, 650 mPa·s or more, in some examples, 700 mPa·s or more, in some examples, about 750 mPa·s. In some examples, the vinyl-terminated polyalkylsiloxane has a viscosity at 25° C. or 750 mPa·s or less, in some examples, 700 mPa·s or less, in some examples, 650 mPa·s or less, in some examples, 600 mPa·s or less, in some examples, 550 mPa·s or less, in some examples, 500 mPa·s or less, in some examples, 450 mPa·s or less, in some examples, 400 mPa·s or less, in some examples, 350 mPa·s or less, in some examples, 300 mPa·s or less, in some examples, about 250 mPa·s. In some examples, the vinyl-terminated polyalkylsiloxane has a viscosity at 25° C. of 250 mPa·s to 750 mPa·s, in some examples, 300 mPa·s to 700 mPa·s, in some examples, 350 mPa·s to 650 mPa·s, in some examples, 400 mPa·s to 600 mPa·s, in some examples, 450 mPa·s to 550 mPa·s, in some examples, 450 mPa·s to 500 mPa·s.

In some examples, the vinyl-terminated polyalkylsiloxane may have a vinyl content of 0.05 mmol/g or more, in some examples, 0.06 mmol/g or more, in some examples, 0.07 mmol/g or more, in some examples, 0.08 mmol/g or more, in some examples, 0.09 mmol/g or more, in some examples, 0.1 mmol/g or more, in some examples, 0.11 mmol/g or more, in some examples, 0.12 mmol/g or more, in some examples, 0.13 mmol/g or more, in some examples, 0.14 mmol/g or more, in some examples, 0.15 mmol/g or more, in some examples, 0.16 mmol/g or more, in some examples, 0.17 mmol/g or more, in some examples, 0.18 mmol/g or more, in some examples, 0.19 mmol/g or more, in some examples, 0.2 mmol/g or more, in some examples, 0.3 mmol/g or more, in some examples, 0.4 mmol/g or more, in some examples, 0.5 mmol/g or more, in some examples, about 0.6 mmol/g. In some examples, the vinyl-terminated polyalkylsiloxane may have a vinyl content of 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.19 mmol/g or less, in some examples, 0.18 mmol/g or less, in some examples, 0.17 mmol/g or less, in some examples, 0.16 mmol/g or less, in some examples, 0.15 mmol/g or less, in some examples, 0.14 mmol/g or less, in some examples, 0.13 mmol/g or less, in some examples, 0.12 mmol/g or less, in some examples, 0.11 mmol/g or less, in some examples, 0.1 mmol/g or less, in some examples, 0.09 mmol/g or less, in some examples, 0.08 mmol/g or less, in some examples, 0.07 mmol/g or less, in some examples, 0.06 mmol/g or less, in some examples, about 0.05 mmol/g. In some examples, the vinyl-terminated polyalkylsiloxane may have a vinyl content of 0.05 mmol/g to 0.6 mmol/g, in some examples, 0.06 mmol/g to 0.5 mmol/g, in some examples, 0.07 mmol/g to 0.4 mmol/g, in some examples, 0.08 mmol/g to 0.3 mmol/g, in some examples, 0.09 mmol/g to 0.2 mmol/g, in some examples, 0.1 mmol/g to 0.19 mmol/g, in some examples, 0.11 mmol/g to 0.18 mmol/g, in some examples, 0.12 mmol/g to 0.17 mmol/g, in some examples, 0.13 mmol/g to 0.16 mmol/g, in some examples, 0.14 mmol/g to 0.15 mmol/g.

In some examples, the polyalkylsiloxane containing at least two vinyl groups comprises a pendent vinyl polyalkylsiloxane having the following formula:

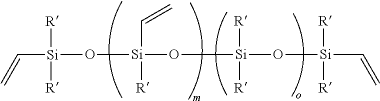

wherein each R′ is independently selected from C1 to C6 alkyl; and m is 1 or more; and o is 0 or more.

In some examples, each R′ is independently selected from C1, C2, C3, C4, C5 and C6 alkyl. In some examples, each R′ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′ is independently selected from methyl, ethyl, n-propyl, isopropyl, n-butyl, sec-butyl, isobutyl, and tert-butyl. In some examples, each R′ is independently selected from methyl, ethyl, n-propyl, and isopropyl. In some examples, each R′ is the same. In some examples, each R′ is methyl.

In some examples, m is 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, m is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples 5 or less. In some examples, m is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500.

In some examples, o is 0 or more, in some examples, 1 or more, in some examples, 2 or more, in some examples, 5 or more, in some examples, 10 or more, in some examples, 50 or more, in some examples, 100 or more, in some examples, 150 or more, in some examples, 200 or more, in some examples, 250 or more, in some examples, 300 or more, in some examples, 350 or more, in some examples, 400 or more, in some examples, 450 or more, in some examples, 500 or more, in some examples, 550 or more, in some examples, 600 or more, in some examples, 650 or more, in some examples, 700 or more, in some examples, 750 or more, in some examples, 800 or more, in some examples, 850 or more, in some examples, 900 or more, in some examples, 950 or more, in some examples, 1000 or more. In some examples, o is 1000 or less, in some examples, 950 or less, in some examples, 900 or less, in some examples, 850 or less, in some examples, 800 or less, in some examples 750 or less, in some examples, 700 or less, in some examples, 650 or less, in some examples, 600 or less, in some examples, 550 or less, in some examples, 500 or less, in some examples, 450 or less, in some examples, 400 or less, in some examples, 350 or less, in some examples, 300 or less, in some examples, 250 or less, in some examples, 200 or less, in some examples, 150 or less, in some examples, 100 or less, in some examples, 50 or less, in some examples, 10 or less, in some examples, 5 or less. In some examples, o is 1 to 1000, in some examples, 2 to 1000, in some examples, 10 to 950, in some examples, 50 to 900, in some examples, 100 to 850, in some examples, 150 to 800, in some examples, 200 to 750, in some examples, 250 to 700, in some examples, 300 to 650, in some examples, 350 to 600, in some examples, 400 to 550, in some examples, 450 to 500

In some examples, the pendent vinyl polyalkylsiloxane has a viscosity at 25° C. of 2500 mPa·s or more, in some examples, 2550 mPa·s or more, in some examples, 2600 mPa·s or more, in some examples, 2650 mPa·s or more, in some examples, 2700 mPa·s or more, in some examples, 2750 mPa·s or more, in some examples, 2800 mPa·s or more, in some examples 2900 mPa·s or more, in some examples, 3000 mPa·s or more, in some examples, 3050 mPa·s or more, in some examples, 3100 mPa·s or more, in some examples, 3150 mPa·s or more, in some examples, 3200 mPa·s or more, in some examples, 3250 mPa·s or more, in some examples, 3300 mPa·s or more, in some examples, 3350 mPa·s or more, in some examples, 3400 mPa·s or more, in some examples, 3450 mPa·s or more, in some examples, about 3500 mPa·s. In some examples, the pendent vinyl polyalkylsiloxane has a viscosity at 25° C. or 3500 mPa·s or less, in some examples, 3450 mPa·s or less, in some examples, 3400 mPa·s or less, in some examples, 3350 mPa·s or less, in some examples, 3300 mPa·s or less, in some examples, 3250 mPa·s or less, in some examples, 3200 mPa·s or less, in some examples, 3150 mPa·s or less, in some examples, 3100 mPa·s or less, in some examples, 3050 mPa·s or less, in some examples, 3000 mPa·s or less, in some examples, 2950 mPa·s or less, in some examples, 2900 mPa·s or less, in some examples, 2850 mPa·s or less, in some examples, 2800 mPa·s or less, in some examples, 2750 mPa·s or less, in some examples, 2700 mPa·s or less, in some examples, 2650 mPa·s or less, in some examples, about 2500 mPa·s. In some examples, the pendent vinyl polyalkylsiloxane has a viscosity at 25° C. of 2500 mPa·s to 3500 mPa·s, in some examples, 2550 mPa·s to 3450 mPa·s, in some examples, 2600 mPa·s to 3400 mPa·s, in some examples, 2650 mPa·s to 3350 mPa·s, in some examples, 2700 mPa·s to 3300 mPa·s, in some examples, 2750 mPa·s to 3250 mPa·s, in some examples, 2800 mPa·s to 3200 mPa·s, in some examples, 2850 mPa·s to 3150 mPa·s, in some examples, 2900 mPa·s to 3100 mPa·s, in some examples, 2950 mPa·s to 3050 mPa·s, in some examples, 3000 mPa·s to 3050 mPa·s.

In some examples, the pendent vinyl polyalkylsiloxane may have a vinyl content of 0.1 mmol/g or more, 0.2 mmol/g or more, in some examples, 0.3 mmol/g or more, in some examples, 0.4 mmol/g or more, in some examples, 0.5 mmol/g or more, in some examples, 0.6 mmol/g or more, in some examples, 0.7 mmol/g or more, in some examples, 0.8 mmol/g or more, in some examples, 0.9 mmol/g or more, in some examples, 1 mmol/g or more, in some examples, 2 mmol/g or more. In some examples, the vinyl-terminated polyalkylsiloxane may have a vinyl content of 2 mmol/g or less, in some examples, 1 mmol/g or less, in some examples, 0.9 mmol/g or less, in some examples, 0.8 mmol/g or less, in some examples, 0.7 mmol/g or less, in some examples, 0.6 mmol/g or less, in some examples, 0.5 mmol/g or less, in some examples, 0.4 mmol/g or less, in some examples, 0.3 mmol/g or less, in some examples, 0.2 mmol/g or less, in some examples, 0.1 mmol/g or less. In some examples, the vinyl-terminated polyalkylsiloxane may have a vinyl content of 0.1 mmol/g to 2 mmol/g, in some examples, 0.2 mmol/g to 1 mmol/g, in some examples, 0.3 mmol/g to 0.9 mmol/g, in some examples, 0.4 mmol/g to 0.8 mmol/g, in some examples, 0.5 mmol/g to 0.7 mmol/g, in some examples, 0.3 mmol/g to 0.6 mmol/g.

In some examples, the polyalkylsiloxane containing at least two vinyl groups comprises a mixture of a vinyl-terminated polyalkylsiloxane having the following formula:

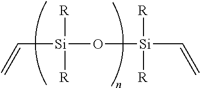

wherein each R is independently selected from C1 to C6 alkyl; and n is 1 or more; and a pendent vinyl polyalkylsiloxane having the following formula:

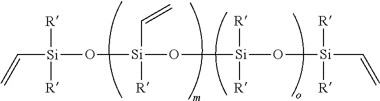

wherein each R′ is independently selected from C1 to C6 alkyl; m is 1 or more; and o is 0 or more. In some examples, the each R, each R′, n, m and o may be as defined above.

In some examples, the polyalkylsiloxane containing at least two vinyl groups comprises a vinyl-terminated polyalkylsiloxane and a pendent vinyl polyalkylsiloxane. In some examples, the polyalkylsiloxane containing at least two vinyl groups comprises a mixture of vinyl-terminated polyalkylsiloxane and pendent vinyl polyalkylsiloxane in a ratio of from 1:10 to 10:1. In some examples, the polyalkylsiloxane containing at least two vinyl groups comprises a mixture of vinyl-terminated polyalkylsiloxane and pendent vinyl polyalkylsiloxane in a ratio of from 1:9 to 9:1 mixture, in some examples, from 1:8 to 8:1, in some examples, from 1:7 to 7:1, in some examples, from 1:6 to 6:1, in some examples, from 1:5 to 5:1, in some examples, from 1:4 to 4:1, in some examples, from 1:3 to 3:1, in some examples, from 1:2 to 2:1, in some examples, from 1:1 to 4:1.

Suitable examples of the polyalkylsiloxane containing at least two vinyl groups include Polymer VS 50, Polymer VS 100, Polymer VS 200, Polymer VS 500, Polymer VS 1000, Polymer VS 200, Polymer RV 100, Polymer RV 200, Polymer RV 500, available from Evonik Industries. Other suitable examples include DMS-V00, DMS-V03, DMS-V05, DMS-V21, DMS-V22, DMS-V25, DMS-V31, DMS-V33, DMS-V34, DMS-V35, DMS-V41, DMS-V42, DMS-V43, DMS-V46, DMS-V51, and DMS-V52 from Gelest Inc., Stroofstrasse 27, Geb.2901, 65933 Frankfurt am Main, Germany).

### Polyalkylsiloxane Cross-Linker Containing at Least Two Si—H Bonds

In some examples, the UV-A curable silicone release formulation comprises a polyalkylsiloxane cross-linker containing at least two Si—H bonds. In some examples, the polyalkylsiloxane cross-linker is selected from a linear polyalkylsiloxane cross-linker, a branched polyalkylsiloxane cross-linker and a cyclic polyalkylsiloxane cross-linker. In some examples, the polyalkylsiloxane cross-linker containing at least two Si—H bonds is a linear polyalkylsiloxane cross-linker.

In some examples, the polyalkylsiloxane containing at least two Si—H bonds comprises a polyalkylsiloxane cross-linker having the following formula:

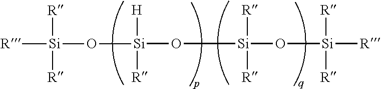

wherein each R″ is independently selected from C1 to C6 alkyl; each R′″ is independently selected from H and C1 to C6 alkyl; p is 2 or more; and q is 0 or more.

In some examples, each R″ is independently selected from C1, C2, C3, C4, C5 and C6 alkyl. In some examples, each R″ is independently selected from methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R″ is independently selected from methyl, ethyl, n-propyl, isopropyl, n-butyl, sec-butyl, isobutyl, and tert-butyl. In some examples, each R″ is independently selected from methyl, ethyl, n-propyl, and isopropyl. In some examples, each R″ is the same. In some examples, each R″ is methyl.

In some examples, each R′″ is independently selected from H, C1, C2, C3, C4, C5 and C6 alkyl. In some examples, each R′″ is independently selected from H, methyl, ethyl, n-propyl, isopropyl, n-butyl, sec-butyl, isobutyl, tert-butyl, pentyl, 2-methylbutan-2-yl, 2,2-dimethylpropyl, 3-methylbutyl, pentan-2-yl, and pentan-3-yl. In some examples, each R′″ is independently selected from H, methyl, ethyl, n-propyl, isopropyl, n-butyl, sec-butyl, isobutyl, and tert-butyl. In some examples, each R′″ is independently selected from H, methyl, ethyl, n-propyl, and isopropyl. In some examples, each R′″ is the same. In some examples, each R′″ is H or methyl.

In some examples, p is 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, p is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less. In some examples, p is 2 to 50, in some examples, 3 to 10, in some examples, 4 to 9, in some examples, 5 to 8, in some examples, 6 to 7.

In some examples, q is 0 or more, in some examples, 1 or more, in some examples, 2 or more, in some examples, 3 or more, in some examples, 4 or more, in some examples, 5 or more, in some examples, 6 or more, in some examples, 7 or more, in some examples, 8 or more, in some examples, 9 or more, in some examples, in some examples, 10 or more, in some examples, 20 or more, in some examples, 50 or more. In some examples, q is 50 or less, in some examples, 20 or less, in some examples, 10 or less, in some examples, 9 or less, in some examples, 8 or less, in some examples, 7 or less, in some examples 6 or less, in some examples, 5 or less, in some examples, 4 or less, in some examples, 3 or less, in some examples, 2 or less, in some examples, 1 or less. In some examples, q is 0 to 50, in some examples, 1 to 10, in some examples, 2 to 9, in some examples, 3 to 8, in some examples, 4 to 7, in some examples, 5 to 6.

In some examples, the polyalkylsiloxane cross-linker may be a random copolymer, a block copolymer, an alternating copolymer or a periodic copolymer. In some examples, the polyalkylsiloxane cross-linker may be a random copolymer.

In some examples, the polyalkylsiloxane cross-linker has a viscosity at 25° C. of 5 mPa·s or more, in some examples, 10 mPa·s or more, in some examples, 15 mPa·s or more, in some examples, 20 mPa·s or more, in some examples, 25 mPa·s or more, in some examples, 30 mPa·s or more, in some examples, 35 mPa·s or more, in some examples 40 mPa·s or more, in some examples, 45 mPa·s or more, in some examples, 50 mPa·s or more, in some examples, 55 mPa·s or more, in some examples, 60 mPa·s or more, in some examples, 65 mPa·s or more, in some examples, 70 mPa·s or more, in some examples, 75 or more, in some examples, about 80 mPa·s. In some examples, the polyalkylsiloxane cross-linker has a viscosity at 25° C. or 80 mPa·s or less, in some examples, 75 mPa·s or less, in some examples, 70 mPa·s or less, in some examples, 65 mPa·s or less, in some examples, 60 mPa·s or less, in some examples, 55 mPa·s or less, in some examples, 50 mPa·s or less, in some examples, 45 mPa·s or less, in some examples, 40 mPa·s or less, in some examples, 35 mPa·s or less, in some examples, 30 mPa·s or less, in some examples, 25 mPa·s or less, in some examples, 20 mPa·s or less, in some examples, 15 mPa·s or less, in some examples, about 10 mPa·s. In some examples, the polyalkylsiloxane cross-linker has a viscosity at 25° C. of 10 mPa·s to 80 mPa·s, in some examples, 15 mPa·s to 75 mPa·s, in some examples, 20 mPa·s to 70 mPa·s, in some examples, 25 mPa·s to 65 mPa·s, in some examples, 30 mPa·s to 60 mPa·s, in some examples, 35 mPa·s to 55 mPa·s, in some examples, 40 mPa·s to 50 mPa·s, in some examples, 40 mPa·s to 45 mPa·s.

In some examples, the polyalkylsiloxane cross-linker may have an Si—H content of 1 mmol/g or more, in some examples, 2 mmol/g or more, in some examples, 3 mmol/g or more, in some examples, 3.5 mmol/g or more, in some examples, 4 mmol/g or more, in some examples, 4.1 mmol/g or more, in some examples, 4.2 mmol/g or more, in some examples, 4.3 mmol/g or more, in some examples, 4.5 mmol/g or more, in some examples, 5 mmol/g or more, in some examples, 6 mmol/g or more, in some examples, 7 mmol/g or more, in some examples, about 8 mmol/g. In some examples, the polyalkylsiloxane cross-linker may have an Si—H content of 8 mmol/g or less, in some examples, 7 mmol/g or less, in some examples, 6 mmol/g or less, in some examples, 5 mmol/g or less, in some examples, 4.5 mmol/g or less, in some examples, 4.4 mmol/g or less, in some examples, 4.3 mmol/g or less, in some examples, 4.2 mmol/g or less, in some examples, 4.1 mmol/g or less, in some examples, 4 mmol/g or less, in some examples, 3.5 mmol/g or less, in some examples, 3 mmol/g or less, in some examples, 2 mmol/g or less, in some examples, about 1 mmol/g. In some examples, the polyalkylsiloxane cross-linker may have an Si—H content of 1 mmol/g to 8 mmol/g, in some examples, 2 mmol/g to 7 mmol/g, in some examples, 3 mmol/g to 6 mmol/g, in some examples, 3.5 mmol/g mmol/g to 5 mmol/g, in some examples, 4 mmol/g to 4.5 mmol/g, in some examples, 4.1 mmol/g to 4.4 mmol/g, in some examples, 4.2 mmol/g to 4.3 mmol/g.

Suitable examples of the polyalkylsiloxane cross-linker include Cross-linker 200, Cross-linker 210, Cross-linker 100, Cross-linker 101, Cross-linker 120, Cross-linker 125 or Cross-linker 190, available from Evonik Industries. Other suitable crosslinkers include HMS-031, HMS-071, HMS-082, HMS-013, and HMS-064 from Gelest Inc., Stroofstrasse 27, Geb.2901, 65933 Frankfurt am Main, Germany).

In some examples, the UV-A curable silicone release formulation comprises a ratio of polyalkylsiloxane containing cross-linker to polyalkylsiloxane containing at least two vinyl groups such that the mole ratio of hydride to vinyl is from 4:1 to 1:4. In some examples, the UV-A curable silicone release formulation comprises a ratio of polyalkylsiloxane containing cross-linker to polyalkylsiloxane containing at least two vinyl groups such that the mole ratio of hydride to vinyl is from 3:1 to 1:3, in some examples, 2.5:1 to 1:2.5, in some examples, 2:1 to 1:2, in some examples, 2:1 to 1:1, in some examples, about 2:1, for example, 2.1:1.

In some examples, the UV-A curable silicone release formulation comprises a weight ratio of polyalkylsiloxane containing cross-linker to polyalkylsiloxane containing at least two vinyl groups of from 1:20 to 1:1, in some examples, 1:19 to 1:2, in some examples, 1:18 to 1:3, in some examples, 1:17 to 1:4, in some examples, 1:16 to 1:5, in some examples, 1:15 to 1:6, in some examples, 1:14 to 1:7, in some examples, 1:13 to 1:8, in some examples, 1:12 to 1:9, in some examples, 1:11 to 1:10. In some examples, the UV-A curable silicone release formulation comprises a weight ratio of polyalkylsiloxane containing cross-linker to polyalkylsiloxane containing at least two vinyl groups of from 1:10.

### UV-A Photoinitiator

A UV-A photoinititator is a photoinitiator or photo-catalyst that is activatable on exposure to UV-A radiation. UV-A photoinitiators are available commercially, an example is QPI-3100™ (available from Polymer-G, Israel) which is designed for curing under UV-A with a wavelength of 395 nm (UV-LED at 395 nm).

On activation of the UV-A photoinititator on exposure to UV-A radiation, the UV-A photoinitiator initiates curing reaction of the polyalkylsiloxane containing at least two vinyl groups and the polyalkylsiloxane cross-linker.

In some examples, the UV-A curable silicone release formulation may comprise, by total weight of the formulation, 2000 ppm or less of a UV-A photoinitiator, in some examples, 1500 ppm or less, in some examples, 1000 ppm or less, in some examples, 500 ppm or less, in some examples, 250 ppm or less, in some examples, 200 ppm or less, in some examples, 150 ppm or less, in some examples, 100 ppm or less, in some examples, 95 ppm or less, in some examples, 90 ppm or less, in some examples, 85 ppm or less, in some examples, 80 ppm or less, in some examples, 75 ppm or less, in some examples, 70 ppm or less, in some examples, 65 ppm or less, in some examples, 60 ppm or less, in some examples, 55 ppm or less, in some examples, 50 ppm or less of a UV-A photoinitiator. In some examples, the UV-A curable silicone release formulation may comprise (by total weight of the formulation) 1 ppm or more of a UV-A photoinitiator, in some examples, 5 ppm or more, in some examples, 10 ppm or more, in some examples, 15 ppm or more, in some examples, 20 ppm or more, in some examples, 25 ppm or more of a UV-A photoinitiator. In some examples, the UV-A curable silicone release formulation may comprise (by total weight of the composition) 1 ppm to 2000 ppm of a UV-A photoinitiator, in some examples, 1 ppm to 1000 ppm, in some examples, 5 ppm to 500 ppm, in some examples, 10 ppm to 250 ppm, in some examples, 10 ppm to 100 ppm, in some examples, 20 ppm to 75 ppm, in some examples, 25 ppm to 50 ppm of a UV-A photoinitiator.

### Thermal Inhibitor

In some examples, the UV-A curable silicone release formulation comprises a thermal inhibitor. In some examples, the thermal inhibitor comprises an acetylenic alcohol or an alkanol. In some examples, the thermal inhibitor inhibits thermal curing of the polyalkylsiloxane containing at least two vinyl groups and the polyalkylsiloxane cross-linker.

In some examples, the UV-A curable silicone release formulation comprises 0.001 wt. % to 10 wt. % thermal inhibitor, in some examples, 0.001 wt. % to 5 wt. %, in some examples, 0.01 wt. % to 2.5 wt. %, in some examples, 0.01 wt. % to 2 wt. %, in some examples, 0.1 wt. % to 1 wt. % thermal inhibitor. In some examples, no thermal inhibitor is used.

Suitable examples of the thermal inhibitor include Inhibitor 600, Inhibitor 500 and Inhibitor 400 from Evonik. Other suitable thermal inhibitors include 1,3-divinyltetramethyldisiloxane(C₈H₁₈OSi₂) and 1,3,5,7-tetravinyl-1,3,5,7-tetramethylcyclotetrasiloxane (C₁₂H₂₄O₄Si₄), both from Gelest Inc.

### Conductive Particles

The UV-A curable silicone release formulation may comprise conductive particles. In some examples, the conductive particles may be an electrically conductive particles. In some examples, the conductive particles may be carbon black particles.

In some examples, the UV-A curable silicone release formulation may comprise 0.01 wt. % to 10 wt. % conductive particles, in some examples, 0.05 wt. % to 9 wt. %, in some examples, 0.1 wt. % to 8 wt. %, in some examples, 0.25 wt. % to 7 wt. %, in some examples, 0.3 wt. % to 6 wt. %, in some examples, 0.4 wt. % to 5 wt. %, in some examples, 0.5 wt. % to 4 wt. %, in some examples, 0.6 wt. % to 3 wt. %, in some examples, 0.7 wt. % to 2.5 wt. %, in some examples, 0.75 wt. % to 2 wt. %, in some examples, 0.8 wt. % to 1.5 wt. %, in some examples 1 wt. % to 2 wt. %, and in some examples 1 wt. % to 1.5 wt. % conductive particles by total weight of the formulation.

In some examples, the UV-A curable silicone release formulation comprises greater than 0.8 wt. % conductive particles, for example carbon black, greater than 1 wt. % conductive particles. In some examples, the UV-A curable silicone release formulation comprises at least 1.1 wt. % conductive particles by total weight of the formulation, for example at least 1.2 wt. %, at least 1.3 wt. %, at least 1.4 wt %, or at least 1.5 wt. %.

Suitable examples of the conductive particles include carbon black particles from AkzoNobel under the name Ketjenblack® EC600JD.

### Method of Making the UV-A Curable Silicone Release Formulation

In some examples, a polyalkylsiloxane containing at least two vinyl groups may be combined with a polyalkylsiloxane cross-linker containing at least two Si—H bonds and a UV-A photoinitiator.

In some examples, a polyalkylsiloxane containing at least two vinyl groups may be combined with a polyalkylsiloxane cross-linker containing at least two Si—H bonds, a UV-A photoinitiator and conductive particles.

In some examples, a polyalkylsiloxane containing at least two vinyl groups may be combined with a polyalkylsiloxane cross-linker containing at least two Si—H bonds, a UV-A photoinitiator, conductive particles and a thermal inhibitor.

In some examples, a polyalkylsiloxane containing at least two vinyl groups may be combined with conductive particles. In some examples a UV-A photoinitiator may be combined with the polyalkylsiloxane containing at least two vinyl groups before, during or after combining of a polyalkylsiloxane containing at least two vinyl groups and conductive particles.

In some examples, the polyalkylsiloxane containing at least two vinyl groups is combined with conductive particles, and optionally the UV-A photoinitiator, under high shear mixing. In some examples, a polyalkylsiloxane cross-linker is then added under further high shear mixing.

In some examples, a polyalkylsiloxane containing at least two vinyl groups may be combined with conductive particles and then a polyalkylsiloxane cross-linker containing at least two Si—H bonds is added.

In some examples, the composition to which a UV-A photoinititator is to be added is protected from light, for example, by wrapping the container in aluminium foil or using a container formed from a light-proof material, before addition of the UV-A photoinititator.

In some examples, the high shear mixing is at 3,000 rpm or more, in some examples, 3,500 rpm or more, in some examples, 4,000 rpm or more, in some examples, 4,500 rpm or more, in some examples, 5,000 rpm or more, in some examples, 5,500 rpm or more, in some examples, 6,000 rpm or more, in some examples, 6,500 rpm or more, in some examples, 7,000 rpm or more, in some examples 7,500 rpm or more, in some examples, 8,000 rpm or more, in some examples, 8,500 rpm or more, in some examples, about 9,000 rpm. In some examples, the high shear mixing is at 9,000 rpm or less, in some examples, 8,500 rpm or less, in some examples, 8,000 rpm or less, in some examples, 7,500 rpm or less, in some examples, 7,000 rpm or less, in some examples, 6,500 rpm or less, in some examples, 6,000 rpm or less, in some examples, 5,500 rpm or less, in some examples, 5,000 rpm or less, in some examples, 4,500 rpm or less, in some examples, 4,000 rpm or less, in some examples, 3,500 rpm or less, in some examples, about 3,000 rpm. In some examples, the high shear mixing is at 3,000 rpm to 9,000 rpm, in some examples, 3,500 rpm to 8,500 rpm, in some examples, 4,000 rpm to 8,000 rpm, in some examples, 4,500 rpm to 7,500 rpm, in some examples, 5,000 rpm to 7,000 rpm, in some examples, 5,500 rpm to 6,500 rpm, in some examples, 6,000 rpm to 6,500 rpm.

In some examples, the UV-A curable silicone release formulation is stored in the dark.

### Method of Producing an Intermediate Transfer Member

In an aspect, there is provided a method of producing an intermediate transfer member for digital offset printing, comprising: applying onto an intermediate transfer member body a UV-A curable silicone release formulation; irradiating the UV-A curable silicone release formulation with UV-A light to form a cured silicone release layer; wherein the UV-A curable silicone release formulation comprises: a polyalkylsiloxane containing at least two vinyl groups; a polyalkylsiloxane cross-linker containing at least two Si—H bonds; and a UV-A photoinitiator.

The method comprises applying onto an intermediate transfer member body a UV-A curable silicone release formulation. The intermediate transfer member body may comprise one or more of a metal base, a fabric layer, a compressible layer and a conductive layer as described herein, with the layer of UV-A curable silicone release formulation being applied to the conductive layer. In some examples, the layer comprising a UV-A curable silicone release formulation is as described herein.

In some examples, the UV-A curable silicone release formulation is applied onto the ITM body by extrusion, calendering, lamination, gravure coating, rod coating, flexo coating, screen coating, spray coating, gravure coating, roll coating, reverse roll coating, gap coating, slot die coating, immersion coating, curtain coating, air knife coating, flood coating, lithography, or combinations thereof. Using these methods, the UV-A curable silicone release formulation can be processed in a straightforward manner with or without the use of solvents.

In some examples, the UV-A curable silicone release formulation is applied onto the ITM body at a gravure volume of 5 cm²/m³ or more, in some examples, 10 cm²/m³ or more, in some examples, 11 cm²/m³ or more, in some examples, 12 cm²/m³ or more, in some examples, 13 cm²/m³ or more, in some examples, 14 cm²/m³ or more, in some examples, 15 cm²/m³ or more, in some examples, 20 cm²/m³ or more. In some examples, the UV-A curable silicone release formulation is applied onto the ITM body at a gravure volume of 20 cm²/m³ or less, in some examples, 15 cm²/m³ or less, in some examples, 14 cm²/m³ or less, in some examples, 13 cm²/m³ or less, in some examples, 12 cm²/m³ or less, in some examples, 11 cm²/m³ or less, in some examples, 10 cm²/m³ or less, in some examples, 5 cm²/m³ or less. In some examples, the UV-A curable silicone release formulation is applied onto the ITM body at a gravure volume of 5 cm²/m³ to 20 cm²/m³, in some examples, 10 cm²/m³ to 15 cm²/m³, in some examples, 11 cm²/m³ to 14 cm²/m³, in some examples, 12 cm²/m³ to 14 cm²/m³, in some examples, 13 cm²/m³ to 14 cm²/m³.

The method may comprise applying a coating of a primer, optionally a radiation curable primer, onto the ITM body. In some examples, the coating of a radiation curable primer is applied using gravure coating, calendering, rod coating, flexo coating, screen coating, spray coating, gravure coating, roll coating, reverse roll coating, gap coating, slot die coating, immersion coating, curtain coating, air knife coating, flood coating, lithography, or combinations thereof.

In some examples, the coating of the primer, optionally, the radiation curable primer, is applied onto the ITM at a layer thickness as described herein. In some examples, the composition of the radiation curable primer is as described below.

### First Primer

A first primer layer, which may also be referred to as a radiation curable or radiation cured primer layer, may be provided on the outer surface of the ITM body. The first primer layer may facilitate bonding or joining of the UV-A curable silicone release layer to the ITM body. The first primer layer may be formed from a radiation curable primer. The radiation curable primer may be applied by using a rod coating process or gravure coating process.

In some examples, the radiation curable primer is cured by UV light. The radiation curable primer may comprise a cross-linking compound capable of cross-linking to the outer surface of the layer of the ITM body on which it is disposed when irradiated with UV light. In some examples, the radiation curable primer may comprise a functional organosilane. In some examples, the organosilane contained in the radiation curable primer layer is selected from an epoxysilane, a vinyl silane, an allyl silane and an unsaturated silane, for example an acrylate functional silane, a methacrylate functional silane, an epoxysilane and mixtures thereof.

In some examples, the functional organosilane compound comprises, for example, a methacryloxypropyl trimethoxysilane, such as Dynasylan® MEMO™ (3-methacryloxypropyltrimethoxysilane) available from Degussa, AG of Piscataway, N.J.

In some examples, an epoxysilane is used in the first primer. In some examples, an epoxysilane, such as 3-glycidoxypropyl trimethoxysilane (available from ABCR GmbH & Co. KG) is used.

In some examples, the radiation curable primer comprises a photoinitiator to facilitate cross-linking of the functional organosilane to itself and with the surface of the layer of the ITM body on which it is disposed. In some examples, the photoinitiator includes, but is not limited to, α-hydroxyketones, α-aminoketones, benzaldimethyl-ketal, and mixtures thereof. In one example, the photoinitiator can comprise Darocur® 1173™, available from BASF, which comprises 2-hydroxy 2-methyl 1-phenyl 1-propanone, CAS number 7473-98-5. Other suitable photoinitiators include, but are not limited to, Irgacure® 500™ (a 50/50 blend of 1-hydroxy-cyclohexyl phenyl ketone and benzophenone), Irgacure® 651™ (an α,α-dimethoxy α-phenyl acetophenone), Irgacure® 907™ (2-methyl-1-[4-(methylthio)phenyl]-2-(4-morpholinyl)-1-propanone) from BASF. Additionally, any other suitable photoinitiators may be used. Generally, the photoinitiator can comprise about 1 wt. % to about 20 wt. % of the total first primer composition. In one example, the photoinitiator can comprise about 1 wt. % to about 5 wt. % of the total first primer composition.

In some examples, the coating of the radiation curable primer is applied onto the layer of the ITM body on which it is disposed at a layer thickness of 10 μm or less, for example, 5 μm or less, for example, 4 μm or less, for example, 3 μm or less, for example, 2 μm or less, for example, 1 μm or less, for example, 0.5 μm or less, for example, about 250 nm. In some examples, the coating of the radiation curable primer is applied onto the layer of the ITM body on which it is disposed at a layer thickness of 250 nm or more, for example, 0.5 μm or more, for example, 1 μm or more, for example, 2 μm or more, for example, 4 μm or more, for example, 5 μm or more, for example, about 10 μm. In some examples, the coating of the radiation curable primer is applied onto the layer of the ITM body on which it is disposed at a layer thickness of from 250 nm to 10 μm, for example, from 0.5 μm to 5 μm, for example, about 1 μm.

### Second Primer

A second primer composition, which may also be referred to as a curable composition, is provided on the outer surface of the first primer already applied to the ITM body. The curable composition is applied to the outer surface of the first primer after curing of the first primer by irradiation. The curable composition may be applied using a rod coating process or gravure coating. The second primer composition facilitates bonding of the UV-A curable silicone release layer to the ITM body layer via the first primer.

In some examples, the curable composition is thermally curable. In some examples, the curable composition comprises a reactive monomer with addition polymerisable groups and condensation polymerisable groups. In some examples, the curable composition comprises a functional silane. Examples of functional silanes that can be used in the curable composition include but are not limited to an epoxysilane, an amino functional silane, an alkylsilane, a vinyl silane, an allyl silane, an unsaturated silane, a non-functional dipodal silane (e.g., bis triethoxysilyl octane), and their condensed forms constituted by oligomers of the monomeric form of the silane.

In some examples, the functional silane comprises a hydrolysable portion. In some examples, the hydrolysable portion of the silane comprises an alkoxy group (e.g., alkoxysilane with an alkoxy group selected from the group consisting of methoxy, ethoxy, propoxy, isopropoxy, methoxyethoxy, and the like). In some examples, the functional silane comprises an epoxyalkyl alkoxysilane (e.g., glycidoxypropyl trimethoxysilane-silane Dynasilan GLYMO (Degussa). In some examples, the hydrolyzable group may also be an oxime group (e.g., methylethylketoxime group) or an acetoxy group. Another illustrative example of an organosilane useful in the second primer is a hydrolysable vinyl silane, for example vinyltriethoxysilane (VTEO, available from Evonik, Kirschenallee, Darmstadt, 64293, Germany), a hydrolysable allyl silane or a hydrolysable unsaturated silane. In some examples, the second primer may comprise (3-glycidoxypropyl)trimethoxysilane and/or vinyltrimethoxysilane.

The curable composition may comprise first and second catalysts, which are different to each other. In some examples, the first and second catalysts catalyse different types of polymerisation reaction. In some examples, the first catalyst catalyses a condensation polymerisation reaction. In some examples, the second catalyst catalyses an addition polymerisation reaction. In some examples, the curable composition comprises first and second catalysts, with the first catalyst catalysing the curing of the curable composition and the second catalyst catalysing the curing of the curable silicone release formulation. In some examples, the first catalyst also catalyses the cross-linking of the curable composition to the radiation-cured first primer. In some examples, the second catalyst also catalyses the cross-linking of the curable composition to the UV-A curable silicone release formulation.

In some examples, the first catalyst component of the curable composition comprises a titanate or a tin catalyst, or, alternatively, comprises any suitable compound that is capable of catalysing a condensation curing reaction of the organosilane of the curable composition. In certain embodiments, the first catalyst comprises an organic titanate catalyst such as acetylacetonate titanate chelate, available as, for example, Tyzor® AA-75 from E.I. du Pont de Nemours and Company of Wilmington, Del.)

In some examples, the first catalyst comprises about 1 wt. % to 20 wt. % of the total primer layer. In some examples, the first catalyst comprises about 1 wt. % to 5 wt. % of the total primer layer. Without being bound by theory, it is believed that acetylacetonate titanate chelate (Tyzor® AA-75) initiates a condensation reaction between the first and second primer components, inducing adhesion between the first and second primers.

In some examples, the second catalyst comprises platinum, or any other catalyst capable of catalysing an addition cure curing reaction of the second primer or curable composition. In some examples, the second catalyst comprises platinum or rhodium. In some examples, the second catalyst comprises a Karstedt catalyst with for example 9 wt. % or 10 wt. % platinum in solution (available from Johnson Matthey, 5th Floor, 25 Farringdon Street, London EC4A 4AB, United Kingdom) or SIP6831.2 catalyst (available from Gelest, 11 East Steel Road, Morrisville, Pa. 19067, USA).

In some examples, the coating of the curable composition primer is applied onto the radiation cured primer layer at a layer thickness of 10 μm or less, for example, 5 μm or less, for example, 4 μm or less, for example, 3 μm or less, for example, 2 μm or less, for example, 1 μm or less, for example, 0.5 μm or less, for example, about 250 nm. In some examples, the coating of the curable composition primer is applied onto radiation cured primer layer at a layer thickness of 250 nm or more, for example, 0.5 μm or more, for example, 1 μm or more, for example, 2 μm or more, for example, 4 μm or more, for example, 5 μm or more, for example, about 10 μm. In some examples, the coating of the curable composition primer is applied onto the radiation cured primer layer at a layer thickness of from 250 nm to 10 μm, for example, from 0.5 μm to 5 μm, for example, about 1 μm.

The method may comprise irradiating the coating of radiation curable primer to provide a coating of cured primer. In some examples, the coating of radiation curable primer is irradiated with light having a wavelength that corresponds to the optimal wavelength for the photoinitiator. In some examples, the step of irradiating comprises irradiating the coating of radiation curable primer using UV irradiation. The duration of the irradiation will depend on the power rating of the radiation source being used and the actual power supplied. In some examples, irradiating the coating of radiation curable primer comprises irradiating in order to fully cure the primer. In some examples, irradiating the coating of radiation curable primer comprises irradiating in order to at least partially cure the primer. In some examples, the radiation-cured primer composition comprises a polymerisation product of an epoxysilane, a vinyl silane, an allyl silane, an acrylate functional silane, and a methacrylate functional silane, and mixtures thereof.

The method may comprise applying onto the coating of cured primer a second primer in the form of a curable composition comprising first and second catalysts. In some examples, the curable composition is applied using gravure coating, calendering, rod coating, flexo coating, screen coating, spray coating, gravure coating, roll coating, reverse roll coating, gap coating, slot die coating, immersion coating, curtain coating, air knife coating, flood coating, lithography, or combinations thereof. In some examples, the composition of the curable composition is as described herein.

In some examples, the coating of the curable composition primer is applied onto the radiation cured primer layer at a layer thickness as described herein.

The method may comprise applying onto the curable composition a UV-A curable silicone release formulation. The UV-A curable silicone release formulation may be applied onto the curable composition before any substantial curing of the curable composition has taken place. In some examples, the UV-A curable silicone release formulation is applied onto the curable composition at a layer thickness as described herein.

The method may comprise simultaneously curing the curable primer composition and the UV-A curable silicone release formulation.

In some examples, curing the UV-A curable silicone release formulation occurs by exposing the UV-A curable silicone release formulation to UV-A irradiation.

In some examples, the method comprises curing the UV-A curable silicone release formulation by irradiating the UV-A curable silicone release formulation for 1 second or more, in some examples, 2 seconds or more, in some examples, 3 seconds or more, in some examples, 4 seconds or more, in some examples, 5 seconds or more, in some examples, 6 seconds or more, in some examples, 7 seconds or more, in some examples, 8 seconds or more, in some examples, 9 seconds or more, in some examples, 10 seconds or more, in some examples, 15 seconds or more, in some examples, 20 seconds or more. In some examples, the method comprises curing the UV-A curable silicone release formulation by irradiating the UV-A curable silicone release formulation for 20 seconds or less, in some examples, 10 seconds or less, in some examples, 9 seconds or less, in some examples 8 seconds or less, in some examples, 7 seconds or less, in some examples, 6 seconds or less, in some examples, 5 seconds or less, in some examples, 5 seconds or less, in some examples, 4 seconds or less, in some examples, 3 seconds or less, in some examples, 2 seconds or less, in some examples, 1 second or less. In some examples, the method comprises curing the UV-A curable silicone release formulation by irradiating the UV-A curable silicone release formulation for 1 second to 20 seconds, in some examples, 2 seconds to 10 seconds, in some examples, 3 seconds to 9 seconds, in some examples, 4 seconds to 8 seconds, in some examples, 5 seconds to 7 seconds, in some examples, 5 seconds to 6 seconds.

In some examples, the UV-A curable silicone release formulation passes the UV-A irradiation source, for example, at a speed of 1 m/min or more, in some examples, 2 m/min or more, in some examples, 3 m/min or more, in some examples, 4 m/min or more, in some examples, 5 m/min or more, in some examples, 6 m/min or more, in some examples, 7 m/min or more, in some examples, 8 m/min or more, in some examples, 9 m/min or more, in some examples, 10 m/min or more. In some examples, the UV-A curable silicone release formulation passes the UV-A irradiation source at a speed of 10 m/min or less, in some examples, 9 m/min or less, in some examples, 8 m/min or less, in some examples, 7 m/min or less, in some examples, 6 m/min or less, in some examples, 5 m/min or less, in some examples, 4 m/min or less, in some examples, 3 m/min or less, in some examples, 2 m/min or less, in some examples, 1 m/min or less. In some examples, the UV-A curable silicone release formulation passes the UV-A irradiation source at a speed of 1 m/min to 10 m/min, in some examples, 2 m/min to 9 m/min, in some examples, 2 m/min to 8 m/min, in some examples, 3 m/min to 7 m/min, in some examples, 4 m/min to 6 m/min, in some examples, 5 m/min to 6 m/min.

In some examples, the UV-A irradiation source is an LED UV lamp. It is also possible to use other sources that emit UV-A irradiation, for example in combination with shorter wavelength UV radiation such as UV-B and UV-C radiation, such as a mercury UV lamp.

In some examples, after irradiating with UV-A irradiation, the intermediate transfer member is left at room temperature to ensure full curing of the UV-A curable silicone release layer prior to use in a digital offset printing apparatus. In some examples, after irradiating with UV-A irradiation, the intermediate transfer member is left at room temperature for 24 hours under ambient light to ensure full curing of the UV-A curable silicone release layer prior to use in a digital offset printing apparatus.

In some examples, curing the UV-A curable silicone release formulation comprises irradiating the UV-A curable silicone release layer with UV-A light and then heating the UV-A curable silicone release formulation. In some examples, after irradiating with UV-A irradiation, the intermediate transfer member is heated to ensure full curing of the UV-A curable silicone release layer. In some examples, heating of the ITM involves heating at greater than room temperature, for example heating at a temperature of about 40° C. or greater, about 50° C. or greater, about 60° C. or greater, about 80° C. or greater, about 100° C. or greater, for example able 120° C. In some examples, heating of the ITM involves heating at a temperature greater than room temperature to about 200° C., for example from about 40° C. to about 150° C. In some examples, the ITM is heated for at least 1 hour, for example about 2 hours.

In some examples, the UV-A curable silicone release formulation is applied onto the ITM body, in some examples, onto the primer layer, for example, the second primer layer, with a layer thickness of 1 μm or more, for example, 1.5 μm or more, for example, 2 μm or more, for example, 3 μm or more, for example, 4 μm or more, for example, 5 μm or more, for example, 6 μm or more, for example, 7 μm or more, for example, 8 μm or more, for example, 9 μm or more, for example, 10 μm or more, for example, 11 μm or more, for example, 12 μm or more, for example, 13 μm or more, for example, 14 μm or more, for example, about 15 μm. In some examples, the UV-A curable silicone release formulation is applied onto the ITM body, in some examples, onto the primer layer, for example, the second primer layer, with a layer thickness of 15 μm or less, for example, 14 μm or less, for example, 13 μm or less, for example, 12 μm or less, for example, 11 μm or less, for example, 10 μm or less, for example, 9 μm or less, for example, 8 μm or less, for example, 7 μm or less, for example, 6 μm or less, for example, 5 μm or less, for example, 4 μm or less, for example, 3 μm or less, for example, 2 μm or less, for example, 1.5 μm or less, for example, about 1 μm. For example, the UV-A curable silicone release formulation is applied onto ITM body, in some examples, onto the primer layer, for example, the second primer layer, with a layer thickness of from 1 μm to 15 μm, for example, of from 1.5 μm to 12 μm, for example, of from 3 μm to 10 μm, for example, of from 5 μm to 9 μm.

Accordingly, there is also provided a digital offset printing apparatus comprising an intermediate transfer member, the intermediate transfer member comprising a UV-A cured silicone release layer comprising a cured UV-A curable silicone release formulation, the UV-A curable silicone release formulation comprising:
a polyalkylsiloxane containing at least two vinyl groups;
a polyalkylsiloxane cross-linker containing at least two Si—H bonds; and
a UV-A photoinitiator.

Accordingly, there is also provided a digital offset printing apparatus comprising an intermediate transfer member, the intermediate transfer member comprising a UV-A cured silicone release layer formed by UV-A curing a UV-A curable silicone release formulation comprising:
a vinyl-terminated polyalkylsiloxane having the following formula:

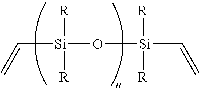

wherein
each R is independently selected from C1 to C6 alkyl; and
n is 1 or more;
a pendent vinyl polyalkylsiloxane having the following formula:

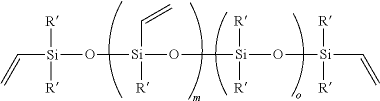

wherein
each R′ is independently selected from C1 to C6 alkyl;
m is 1 or more; and
o is 0 or more
a polyalkylsiloxane cross-linker having the following formula:

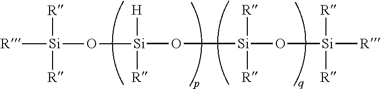

wherein
each R″ is independently selected from C1 to C6 alkyl;
each R′″ is independently selected from H and C1 to C6 alkyl;
p is 2 or more; and
q is 0 or more; and
a UV-A photoinitiator.

The digital offset printing apparatus may further comprise one or more print stations or printheads, a primer station and a radiation source, and be adapted, in use, to apply a primer to the intermediate transfer member; jet a radiation curable inkjet ink onto the primer to form a print image on the intermediate transfer member; and irradiate the image and primer to at least partially cure the radiation curable inkjet ink and the primer on the intermediate transfer member, and transferring the print image to a print substrate.

Accordingly, there is also provided a method of digital offset printing on a printing apparatus comprising an intermediate transfer member, the intermediate transfer member comprising a UV-A cured silicone release layer formed by UV-A curing a UV-A curable silicone release formulation comprising:
a polyalkylsiloxane containing at least two vinyl groups;
a polyalkylsiloxane cross-linker containing at least two Si—H bonds; and
a UV-A photoinitiator;
the printing method comprising generating on the intermediate transfer member a print image, and transferring the print image from the intermediate transfer member to a print substrate.

Accordingly, there is also provided a method of digital offset printing on a printing apparatus comprising an intermediate transfer member, the intermediate transfer member comprising a UV-A cured silicone release layer formed by UV-A curing a UV-A curable silicone release formulation comprising:
a vinyl-terminated polyalkylsiloxane having the following formula:

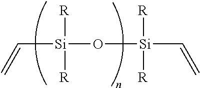

wherein
each R is independently selected from C1 to C6 alkyl; and
n is 1 or more;
a pendent vinyl polyalkylsiloxane having the following formula:

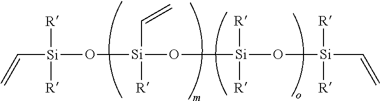

wherein
each R′ is independently selected from C1 to C6 alkyl;
m is 1 or more; and
o is 0 or more
a polyalkylsiloxane cross-linker having the following formula:

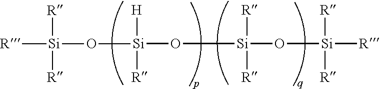

wherein
each R″ is independently selected from C1 to C6 alkyl;
each R′″ is independently selected from H and C1 to C6 alkyl;
p is 2 or more; and
q is 0 or more; and
a UV-A photoinitiator;
   the printing method comprising generating on the intermediate transfer member a print image, and transferring the print image from the intermediate transfer member to a print substrate.

In some examples, the step of generating on the intermediate transfer member a print image comprises printing an ink composition onto a photo-imaging cylinder to generate a developed toner image or print image and transferring the developed toner image or print image onto the intermediate transfer member. In some examples, the step of generating on the intermediate transfer member a print image comprises printing an ink composition directly onto the intermediate transfer member to generate a developed toner image or print image. In some examples, the ink composition is a liquid electrophotographic ink composition or an inkjet ink composition. In other words, the method of digital offset printing may be a liquid electrophotographic printing method using a liquid electrophotographic ink composition, or a transfer inkjet printing method using an inkjet ink composition.

In some examples, the developed toner or print image is at least partially dried and fused on the intermediate transfer member. The drying and fusing step may be facilitated by heating of the intermediate transfer member and/or a stream of heated air directed to the surface of the intermediate transfer member having the developed toner image thereon. As a final step, the dried and fused print image is transferred to a print substrate. Any suitable substrate may be used, and may comprise a paper substrate, a paperboard substrate, a polymer film, or a metallized version of the aforementioned substrates.

### EXAMPLES

### Materials

UV-A photoinitiator—QPI-3100™ (UV-LED photo-catalyst supplied as 1000 ppm concentration in vinyl silicone, available from Polymer-G (Israel)).

Primer G [(3-Glycidoxypropyl)trimethoxysilane; available from Sigma-Aldrich]:

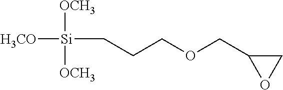 [SMILES: CO[Si](CCCOCC1CO1)(OC)OC]

MEMO (3-Methacryloxypropyltrimethoxysilane; available from Evonik Industries):

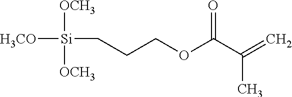 [SMILES: C=C(C)C(=O)OCCC[Si](OC)(OC)OC]

Duracur® 1173 (available form Ciba®):

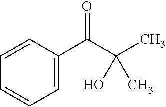

V3M (vinyltrimethoxysilane; available from Sigma-Aldrich):

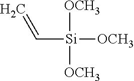

Tyzor AA-75 (75 wt. % in isopropanol; available from Dorf-Ketal)

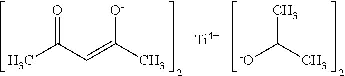

Karstedt's catalyst (platinum divinyl tetramethyl disiloxane complex; 9 wt. % in isopropanol; purchased from Johnson Matthey and used as received):

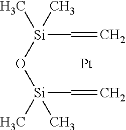

Polymer VS500 (vinyl-terminated polydimethylsiloxane; available from Evonik Industries):

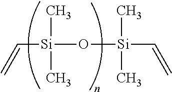

Polymer RV 5000 (pendent vinyl polydimethylsiloxane, viscosity 3000 cps; available from Evonik Industries):

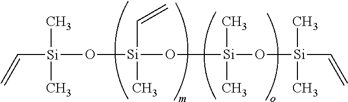

Cross-linker 210 (CL210; a polydimethylsiloxane containing at least two Si—H bonds; available from Evonik Industries):

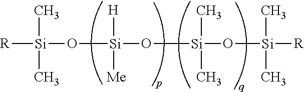

in which R=Me, p is 2 or more; and q is 0 or more.

Inhibitor 600 (an alkinol in Polymer VS; available from Evonik Industries).

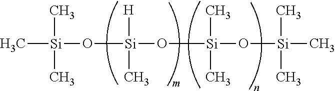

Carbon Black: Ketjenblack® EC600JD from AkzoNobel.

### UV-A Curable Silicone Release Formulation

### Example 1

A vinyl-terminated polydimethylsiloxane (polymer VS500; viscosity: 500 mPa·s) was mixed with a pendent vinyl polydimethylsilicoxane (polymer RV5000; viscosity: 3,000 mPa·s) at a weight ratio of 4:1 VS500 RV5000. To this was added a UV-A photoinitiator (QPI-3000) to give a final UV-A photoinitiator concentration of 50 ppm. Conductive particles (carbon black; 0.8 wt. %) were then added to the mixture and the mixture was homogenized at 6000 rpm for 3 minutes using a high-shear mixer. This concentrate (described as master batch) with the UV-A photoinitiator and carbon blank was kept in the dark until used. The UV-A curable silicone release formulation was formed by adding 10 parts of a polydimethylsiloxane cross-linker containing at least two Si—H bonds (CL210 cross-linker) to 100 parts of the master batch and homogenized at 3000 rpm for 3 minutes.

### Examples 2-4

The UV-A curable silicone release formulations of Examples 2-4 were prepared according to Example 1, except the amount of the UV-A photoinitiator and a thermal inhibitor (Inhibitor 600) added (were used the inhibitor was added along with the polydimethylsiloxane cross-linker) which is set out in table 1 below.

TABLE 1

| | Amount UV-A photoinitator | Amount thermal inhibitor by |
|---|---|---|
| Example | in formulation (ppm) | total weight of formulation |
| 1 | 50 | 0 |
| 2 | 25 | 0 |
| 3 | 50 | 0.25 wt % |
| 4 | 25 | 0.25 wt % |

Samples of each of the formulations of Examples 1-4 were tested for thermal stability by heating in an oven at 120° C. for 5 hours in the absence of UV-A light. Each of the formulations were found to show no sign of solidification after 5 hours. However, the same samples when exposed to UV-LED (395 nm) at a belt speed of 5 m/min solidified almost instantaneously. This result demonstrates the excellent thermal stability of these UV-A curable silicone release formulations.

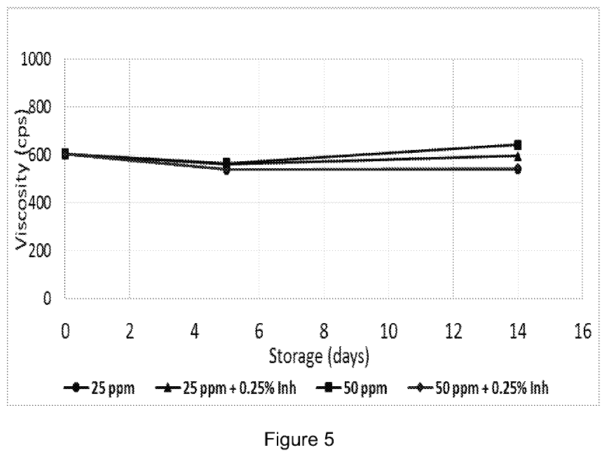

Samples of the formulations of each of Examples 1-4 were kept at room temperature and wrapped in aluminium foil to insure minimal exposure to ambient light. The viscosities of these samples were tested over a period of two weeks. The results are shown in FIG. 5. As can be seen from FIG. 5, without inhibitor, the formulation containing 25 ppm QPI-3100™ was stable with almost no increase in the viscosity. The formulation containing 50 ppm QPI-3100™, on the other hand, showed a slight increase in viscosity from ca. 600 cps to ca. 640 cps. This minor and negligible increase in the viscosity might be attributed to the slight exposure to ambient light during viscosity measurements. With 0.5 w % thermal inhibitor, the viscosity of the formulation did not change for both UV-A photoinitiator concentrations. It is important to note the very low concentrations of the inhibitor used (if any). By comparison, thermal addition-cure formulations require at least 5-10 wt % on total formulation weight, which at least 10-20 fold more than the thermal inhibitor used in the formulation of Examples 3 and 4.

### Preparation of ITM Body for the Application of the Silicone Release Formulation

A three-layered intermediate transfer member blanket precursor comprising a rubber based conductive layer disposed on a rubber based compressible layer disposed on a fabric based adhesive layer (a web press of series Ill) was provided. A soft compliant layer (CSL) was laminated onto the rubber based conductive layer to form an intermediate transfer member body. The intermediate transfer member body was heated at 90° C. for 12 h to ensure full curing of the soft compliant layer prior to application of the UV-A curable silicone release formulation.

Preparation of the Intermediate Transfer Member with UV-A Cured Silicone Release Layer

For the adhesion of the UV-A curable silicone release formulation on the CSL, two primer layers were applied to the CSL of the ITM body. All coatings were applied by using a continuous set of gravure coaters at a constant coating speed of 5 m/min. Primer 1 comprising Primer G, MEMO and Darocur in a ratio of 45:50:5 (wt./wt./wt.) was applied on the surface of the CSL (gravure volume of 2 cm²/m³) followed by UV irradiation (using a mercury UV lamp). The UV irradiation at this stage induces the polymerization of MEMO to produce a sticky surface for the second primer. After that, primer 2 comprising Primer G, V3M, Tyzor AA-75 and Karstedt's catalyst in a ratio of 58:26:8:8 (wt./wt./wt./wt.) was applied (gravure volume of 10.5 cm²/m³) followed by the UV-A curable silicone release formulation of Example 1 (gravure volume of 13.8 cm²/m³). The multi-layered structure was passed under a UV-A source (FirePower FP300 UV-LED lamp from Phoseon Technology (Hillsboro, Oreg., USA)). The emitting window size was 150×20 mm with peak irradiance of 20 W/cm² @395 nm. An average surface height of 8 mm was used. At this height, the peak irradiance was measured to be 10.8 W/cm². Fusion belt with a speed ranging from 1 m/m to 7 m/min was used for controlling the exposure time under the UV-LED lamp. Exposure time under the UV-LED lamp was also varied by employing consecutive exposure cycles. After exposure to UV-A the ITM was then kept in an oven as 120° C. for 2 hours to fully cure the CSL (ACM based and supplied semi-cured).

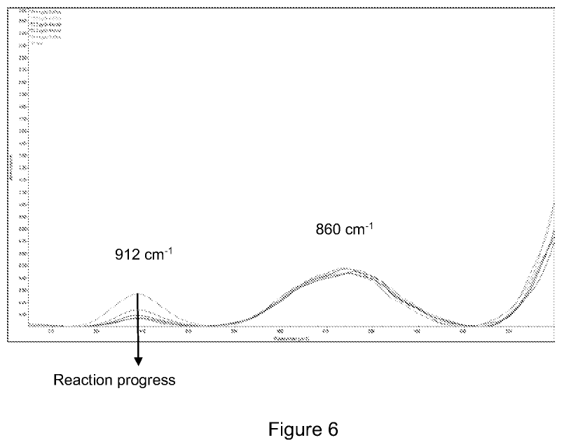

Reaction progress of the UV-A curing of the UV-A curable silicone release formulation was monitored by Attenuated Total Reflectance Fourier-Transform Infrared spectroscopy (ATR-FTIR) according to Esteves et al. (Polymer 50, 3955-3966, 2009). FIG. 6 shows an example of ATR-FTIR spectra taken during curing of the UV-A curable silicone release formulation of Example 1. This figure shows 6 superimposed spectra taken as the reaction progresses. The ATR-FTIR spectra were used to calculate the % conversion of the curing reaction of the UV-A curable silicone release formulation. % Conversion was calculated using the integrated area of the Si—H bending peak of the polyalkylsiloxane cross-linker at 912 cm⁻¹, with the peak located at 860 cm⁻¹ attributed to the Si—C stretching vibration of polydimethylsilosxane Si—CH₃ groups used to normalized the spectra. With reaction progress of the integrated peak ratio —SiH/Si—CH₃ decreases until the complete disappearance of the —SiH band indicating full cure (i.e. 100% conversion).

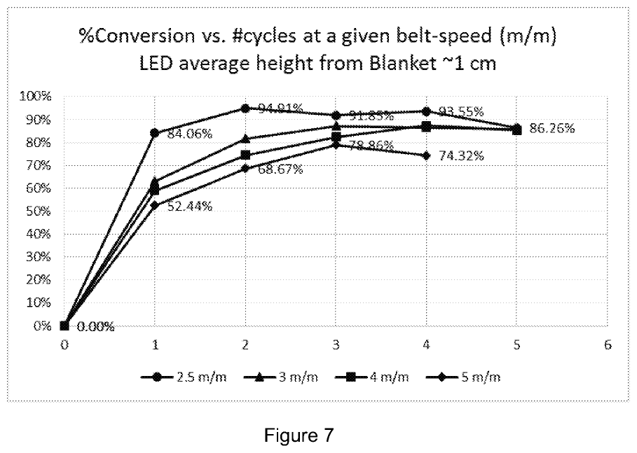

The % conversion as a function of exposure cycles, i.e. number of passing under UV-LED lamp at a given belt speed is shown in FIG. 7. At a speed of 5 m/min a single exposure cycle resulted in about 52% conversion. Additional exposure at the same speed resulted in an increase in conversion up to about 80% after four consecutive exposure cycles. Decreasing the belt speed to 4 m/min resulted in further increase in % conversion per cycle. As belt speed decreases the exposure time increases which increases the % conversion. The highest conversion per cycle was achieved at a belt speed to 2.5 m/m where ca. 84% conversion was measured.

The total accumulated energy (joule/cm²) at a belt speed of 5 m/min was calculated according to the following equations:

Measured peak irradiance at 8 mm distance=10.8 W/cm²

Width of the UV-LED lamp=20 mm=2 cm

Belt speed=5 m/min=500 cm/60 s=8.34 cm/s

Exposure time=distance/speed=2 cm/8.34 (cm/s)=0.24 s

Total accumulated energy per cycle=peak irradiance×exposure time=10.8×0.24=2.59 J/cm²

Total accumulated energy per n number of cycles at belt speed of 5 m/m=n×2.59 J/cm²

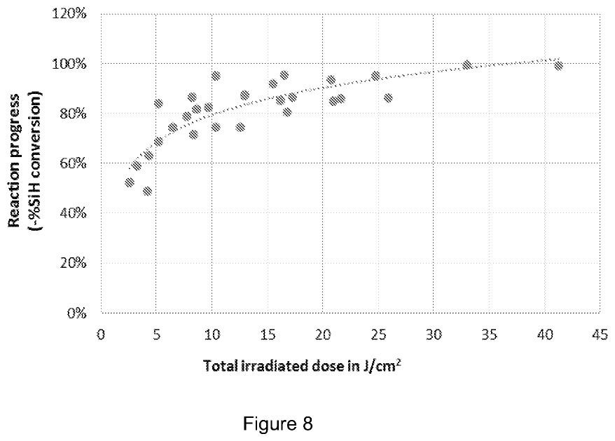

Total doses with lower belt speeds were also calculated using the method described above. FIG. 8 shows the % conversion vs. total accumulated energy for all belt speeds and number of exposure cycles. As can be clearly seen, about 40-50% conversion is achieved when the total accumulated energy was between 2.5-5 J/cm². 60-80% conversion was achieved with 5-10 J/cm²; whereas, almost complete conversion (>90%) was achieved when the total irradiated dose was >15 J/cm². It is possible to decrease further the surface height of the UV-LED lamp and thus to increase the irradiance peak; however, this was avoided to prevent blanket overheating due to the presence of considerable percentage of carbon black in the ITM.

The inventors have found that a further advantage of providing a silicone release formulation comprising a UV-A photoinitiator, as described, is that the UV-A photoinitiator appears to be able to continue catalysing the curing reaction even after the cessation of UV-A irradiation. This continued curing after removal from UV-A radiation is summarized in table 2 below. Table 2 shows the measured % conversion after passing the formulation of Example 1 under UV-LED (FirePower FP300 UV-LED lamp from Phoseon Technology (Hillsboro, Oreg., USA)) at a speed of 5 m/min and how this % conversion increases with either thermal post-curing at 120° C. for 2 hours in the absence of light (including absence of UV-A) or post-curing at room temperature and ambient light for 24 hrs. For comparison a reference thermally curable formation (prepared in a similar way to Example 1 except that a thermally activatable platinum catalyst was added in an amount of 0.25 wt % by total weight of the formulation instead of the UV-A photoinitiator) was also tested, curing for this sample was complete after curing at 120° C. for 2 hours. However, the reference thermally curable formulation had a very limited shelf life (around one and a half hours).

TABLE 2

| | | Total irradiated | % Conversion | | % Conversion |
|---|---|---|---|---|---|
| Formulation | Curing method | UV dose (J/cm²) | after UV | Post-cure | after post-cure |
| Ref | 2 hrs @ 120° C. | — | — | — | 100% |
| Ex 1 | UV-LED (5 m/m) | 2.6 | ~50% | 2 hrs @ 120° C. | 100% |
| Ex 1 | UV-LED (5 m/m) | 2.6 | ~50% | 24 hrs @ room | 82% |
| | | | | temp, ambient light | |

These results show, that in addition to vastly improved shelf-life of the UV-A curable silicone release formulations described herein compared to conventional thermally curable formulations, these UV-A curable silicone release formulations can be fully cured by means of a small amount of UV-A exposure followed by thermal post curing. As discussed above, the UV-A curable silicone release formulations were found to be stable and uncured after heating to 120° C. for 5 hours, therefore the UV-A curable silicone release formulations are not thermally curable without exposure to UV radiation which provides the advantage of stability of these formulations compared to conventional thermally curable formulations. The improved stability of these formulations allows for more efficient production of ITMs, for production of ITMs using these UV-A curable silicone release formulations requires a lot less down time, e.g. cleaning and refilling tanks containing the release formulation, compared to thermally curable release formulations.

The inventors have found that employing a UV-A photoinitiator allows curing to be carried out under a UV-A source, such as UV-LED which provides many advantages over curing under traditional UV lamps, such as mercury UV lamps. These advantages include improved curing depth with minimised wrinkling and skinning effect (which has been found to result in release layers having improved homogeneity), improved power consumption and UV-source life time, reduced heat generation, instantaneous switching on and off of the UV-source.

The inventors have found that carbon black can be added in amounts of at least about 1.5 wt. % by total weight of the formulation without affecting the curing of the UV-A silicone release formulation. Increasing the quantity carbon black in a release layer of an ITM provides improvements in negative dot gain and memory of the release layer.

The inventors have found that using a UV-A photoinitiator instead of a photoinitiator activated by shorter UV wavelengths, such as platinum (II) acetylacetonate ([Pt(acac)₂]), allows curing to be carried out at longer (and therefore safer) UV wavelengths as well as generating much less heat than generated by the UV lamps required to activate photoinitiators such as [Pt(acac)₂]. Reducing the amount of heat generated is allows melting, or even burning, of the release layer to be avoided. The inventors have also found that attempting to increase the carbon black content to around 1.5 wt. % of the formulation of UV-curable compositions comprising a photoinitiator activatable at UV wavelengths shorter than UV-A wavelengths (e.g. UV-B and UV-C wavelengths), such as [Pt(acac)₂], causes difficulties with curing the composition.

While the method and related aspects have been described with reference to certain examples, those skilled in the art will appreciate that various modifications, changes, omissions, and substitutions can be made without departing from the spirit of the disclosure. It is intended, therefore, that the present method and related aspects be limited only by the scope of the following claims. The features of any dependent claim can be combined with the features of any of the other dependent claims or independent claims.

1. An intermediate transfer member for digital offset printing, comprising a UV-A cured silicone release layer comprising a cured UV-A curable silicone release formulation, the UV-A curable silicone release formulation comprising:
a polyalkylsiloxane containing at least two vinyl groups;
a polyalkylsiloxane cross-linker containing at least two Si—H bonds; and
a UV-A photoinitiator.

2. The intermediate transfer member for according to claim 1, wherein the polyalkylsiloxane containing at least two vinyl groups is a linear polyalkylsiloxane containing at least two vinyl groups.

3. The intermediate transfer member for according to claim 1, wherein the polyalkylsiloxane containing at least two vinyl groups comprises a vinyl-terminated polyalkylsiloxane having the following formula: 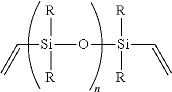
wherein
each R is independently selected from C1 to C6 alkyl; and
n is 1 or more.

4. The intermediate transfer member according to claim 3, wherein each R is methyl.

5. The intermediate transfer member according to claim 1, wherein the polyalkylsiloxane containing at least two vinyl groups comprises a pendent vinyl polyalkylsiloxane having the following formula: 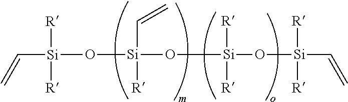
wherein
each R′ is independently selected from C1 to C6 alkyl;
m is 1 or more; and
o is 0 or more.

6. The intermediate transfer member according to claim 5, wherein R′ is methyl.

7. The intermediate transfer member according to claim 1, wherein the UV-A cured silicone release formulation further comprises conductive particles.

8. The intermediate transfer member according to claim 7, wherein the UV-A cured silicone release formulation comprises carbon black.

9. The intermediate transfer member according to claim 8, wherein the UV-A cured silicone release formulation comprises carbon black in an amount greater than 1 wt. % by total weight of the formulation.

10. The intermediate transfer member according to claim 1, wherein the polyalkylsiloxane cross-linker containing at least two Si—H bonds comprises a polyalkylsiloxane cross-linker having the following formula, 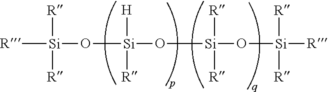
wherein
each R″ is independently selected from C1 to C6 alkyl;
each R′″ is independently selected from H and C1 to C6 alkyl;
p is 2 or more; and
q is 0 or more.

11. The intermediate transfer member according to claim 10, wherein R″ is methyl.

12. The intermediate transfer member according to claim 10, wherein p is 2 to 50.

13. The intermediate transfer member according to claim 10, wherein q is 0 to 50.

14. A method of producing an intermediate transfer member for digital offset printing, comprising:
applying onto an intermediate transfer member body a UV-A curable silicone release formulation; and
curing the UV-A curable silicone release formulation to form a cured silicone release layer,
wherein the UV-A curable silicone release formulation comprises:
a polyalkylsiloxane containing at least two vinyl groups;
a polyalkylsiloxane cross-linker containing at least two Si—H bonds; and
a UV-A photoinitiator,
and curing the UV-A curable silicone release formulation comprises irradiating the UV-A curable silicone release layer with UV-A light.

15. A UV-A curable silicone release formulation for an intermediate transfer member of a digital offset printing apparatus, comprising:
a vinyl-terminated polyalkylsiloxane having the following formula: 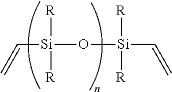
wherein
each R is independently selected from C1 to C6 alkyl groups; and
n is 1 or more;
a pendant vinyl polyalkylsiloxane having the following formula: 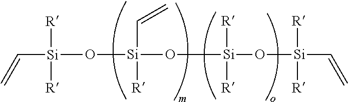
wherein
each R′ is independently selected from C1 to C6 alkyl groups;
m is 1 or more; and
o is 0 or more;
a polyalkylsiloxane cross-linker having the following formula: 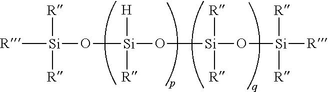
wherein
each R″ is independently selected from C1 to C6 alkyl;
each R′″ is independently selected from H and C1 to C6 alkyl;
p is 2 or more; and
q is 0 or more; and
a UV-A photoinitiator.
